(19) United States
(12) Patent Application Publication
(10) Pub. No.: US 2019/0085273 A1
(43) Pub. Date: Mar. 21, 2019

(54) ENCAPSULATED LAUNDRY CLEANING COMPOSITION

(71) Applicant: BASF SE, Ludwigshafen am Rhein (DE)

(72) Inventors: Keith E. Gutowski, Wyandotte, MI (US); Dustin D. Hawker, Wyandotte, MI (US)

(21) Appl. No.: 16/082,673

(22) PCT Filed: Mar. 8, 2017
(86) PCT No.: PCT/US2017/021380

§ 371 Date: Sep. 6, 2018

Related U.S. Application Data
(60) Provisional application No. 62/305,792, filed on Mar. 9, 2016.

(51) Int. Cl. C11D 17/04; C11D 3/34; C11D 3/20

(52) U.S. Cl. CPC C11D 17/043; C08L 29/04; C11D 3/2048; C11D 3/349

(57) ABSTRACT

An encapsulated laundry cleaning composition includes a core cleaning composition and a water-soluble film disposed about the core cleaning composition. The core cleaning composition itself includes a detergent and a solvent system. The solvent system includes an ionic liquid and water. The water-soluble film has a disintegration time of less than 90 seconds as determined at 40° C. using distilled water according to MSTM 205, when disposed about the core cleaning composition.

### FIELD OF THE DISCLOSURE

The disclosure generally relates to an encapsulated laundry cleaning composition. More specifically, this disclosure relates to an encapsulated laundry cleaning composition that includes a core cleaning composition, which includes a detergent and a solvent system including an ionic liquid and water, and a water-soluble film disposed about the core cleaning composition.

### BACKGROUND

Cleaning compositions can be difficult to stabilize and are prone to decomposition and loss of activity (e.g. performance) at both elevated and reduced temperatures and/or over time. Several products, such as detergents, septic tank treatments, and drain cleaners use cleaning agents such as enzymes and surfactants as key ingredients for performance, and sometimes package formulations containing such cleaning agents inside a water-soluble film pouch (e.g. a polyvinyl alcohol (PVA) pouch). However, when the formulation is a liquid or gel, a solvent is usually required to disperse or dissolve the cleaning agents and other formulation ingredients. Although very small amounts of water can be used to facilitate this dissolution, water is detrimental to the pouch and dissolves the pouch prematurely, thereby ruining the product. Other solvents such as glycols, short chain alcohols, and glycol ethers (e.g. propylene glycol, butylene glycol, glycerine) can also be used solvents. However, when these solvents are used, they typically plasticize and deform the pouch, again ruining the product. Moreover, these solvents tend to be poor solvents for many of the formula ingredients, thereby rendering the compositions ineffective for their intended uses. Accordingly, there remains an opportunity for improvement.

### SUMMARY OF THE DISCLOSURE

This disclosure provides an encapsulated laundry cleaning composition that includes a core cleaning composition and a water-soluble film disposed about the core cleaning composition. The core cleaning composition itself includes detergent and a solvent system. The solvent system includes an ionic liquid and water. The water-soluble film has a disintegration time of less than 90 seconds as determined at 40° C. using distilled water according to MSTM 205, when disposed about the core cleaning composition.

### DETAILED DESCRIPTION OF THE DISCLOSURE

This disclosure provides an encapsulated laundry cleaning composition that includes a core cleaning composition and a water-soluble film disposed about the core cleaning composition. It is to be understood that the terminology “disposed about” may encompass both partial and complete covering of the core cleaning composition by the water-soluble film. The partial or complete covering of the core cleaning composition by the water-soluble film encapsulates the core cleaning composition thereby forming the encapsulated cleaning composition. In various embodiments, the core cleaning composition is encapsulated wholly or partially, e.g. by one or more layers of the water-soluble film. In various embodiments, 1, 2, 3, 4, or 5 layers of the water-soluble film are utilized. Each one of these layers may be independently disposed on and in direct contact with any one or more other layers or disposed on, and spaced apart from, any one of more layers.

### Core Cleaning Composition:

The core cleaning composition includes a detergent and a solvent system, which are both described in greater detail below.

In various embodiments, the core cleaning composition is, includes, consists essentially of, or consists of, the detergent and the solvent system. The terminology “consists essentially of” describes embodiments wherein the core cleaning composition includes the recited components but is free of other components that, as would be understood by a person having ordinary skill in the art, may directly interfere with the recited components. For example, the core cleaning composition may be free surfactants, chelants, enzymes, polymers, and/or any optional components not described herein.

### Detergent:

The detergent may be any detergent known in the art. More specifically, the detergent may be any component or mixture of components that can exhibit detersive properties. The detergent may include or be a single component, or may include or be any number of individual components, such as, but not limited to, those described below. In some embodiments, the detergent includes or is only one component (e.g. a surfactant, as described in further detail below). In other embodiments, the detergent includes or is more than 1 component (e.g. a mixture of two or more surfactants). In various embodiments, the detergent includes, or is a combination of, from 1 to 20, 1 to 10, 5 to 10, 5 to 15, 2 to 15, 2 to 5, 3 to 6, or 10 to 20 individual components. However, one of ordinary skill in the art will appreciate that the detergent may include more or fewer components than described above and still be used in the core cleaning composition.

The detergent may be included in the core cleaning composition in an amount of from 1 to 90, 1 to 80, 5 to 50, 5 to 45, 5 to 40, 5 to 35, 5 to 30, 5 to 25, 5 to 20, 5 to 15, 5 to 10, 10 to 40, 10 to 35, 10 to 30, 10 to 25, 10 to 20, 10 to 15, 15 to 40, 15 to 35, 15 to 30, 15 to 25, 15 to 20, 20 to 75, 25 to 75, 25 to 70, 30 to 90, 30 to 89, 30 to 80, 30 to 84, 30 to 75, 35 to 65, 30 to 60, 25 to 50, 45 to 70, 45 to 55, 50 to 60, 20 to 40, 20 to 35, 20 to 30, or 20 to 25 weight percent based on a total weight of the core cleaning composition. All values and ranges of values therebetween are also expressly contemplated herein in various non-limiting embodiments.

### Surfactant:

In various embodiments, the detergent is, includes, consists essentially of, or consists of a surfactant. The surfactant may be any surfactant or mixture of surfactants known in the art. In various embodiments, the surfactant is chosen from substituted and unsubstituted alcohol alkoxylates, alcohol ethoxylates, alkyl/aryl ether sulfates, alkyl/aryl sulfonates, alkyl/aryl sulfates, alkyl betaines, C₁₂ to C₁₈ dialkyl quaternary ammonium salts, EO/PO block copolymers, alkylpolyglucosides, and combinations thereof. The alcohol can be chosen from natural or synthetic feedstocks. It should be appreciated that the term “substituted”, used herein to describe the chemical structures of various components, chemicals, groups, and combinations thereof, is used to describe the inclusion of at least one functional group in the chemical structure of the component, chemical, group, or combinations thereof. Accordingly, the term “substituted” signifies the inclusion of at least one functional group, such as, but not limited to the following functional groups: a hydroxyl, an anhydride, an orthoester, an orthocarbonate ester, an aldehyde, a ketone, an alkene, an alkyne, a diene, a disulfide, an isocyanate, an isothiocyanate, an ester, a carbonate ester, acyl halide, a sulfonyl halide, a sulfonamide, a haloformate, a cyanoformate, a thioester, a phosphoryl chloride, an epoxide, an acetal, a ketal, a sulfonate ester, an alkyl halide, an imidate, an amide, an imine, an imide, a diimide, a cyanate, a nitrile, a nitroso alkyl, a thiocyanate, a thione, a thial, an aziridine, a thiirane, a lactone, a lactam, a phosphate, a phosphoramidate, a phosphorodiamidate, a conjugated polyene, a heterocycle, a heteroaryl, a Lewis acid functional group, and combinations thereof. It should be appreciated that the term “substituted” may describe the inclusion of one, two, three, four, or more, of the functional groups listed above. Moreover, it is further to be appreciated that the term “unsubstituted” is used to describe an absence of any one or more of the functional groups listed above in the chemical structure of a component, chemical, group, or combination thereof, notwithstanding further description of the component, chemical, group, or combination thereof.

In other embodiments, the surfactant includes or is a non-ionic surfactant, an ionic surfactant, a cationic surfactant, a zwitterionic surfactant, or combinations thereof. In one embodiment, the surfactant is a non-ionic surfactant or a non-ionic surfactant system, e.g. having a phase inversion temperature, as measured at a concentration of 1% in distilled water, between 40° C. and 70° C. A “non-ionic surfactant system” typically is a mixture of two or more non-ionic surfactants. The phase inversion temperature is the temperature below which a surfactant, or a mixture thereof, partitions preferentially into a water phase as oil-swollen micelles and above which the surfactant partitions preferentially into an oil phase as water swollen inverted micelles, as understood by one of ordinary skill in the art. Phase inversion temperature can be determined visually by identifying at which temperature cloudiness occurs.

The phase inversion temperature of a non-ionic surfactant or system can be determined as follows: a solution including 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Non-limiting examples of suitable nonionic surfactants include: i) ethoxylated non-ionic surfactants prepared by the reaction of a monohydroxy alkanol or alkylphenol with 6 to 20 carbon atoms typically with at least 12 moles, at least 16 moles, or even at least 20 moles of ethylene oxide per mole of alcohol or alkylphenol; and ii) alcohol alkoxylated surfactants having a from 6 to 20 carbon atoms and at least one ethoxy and propoxy group. In some embodiments, combinations of surfactants i) and ii) are used.

Another class of suitable non-ionic surfactants are epoxy-capped poly(oxyalkylated) alcohols having a structure according to Formula (I):

R¹O[CH₂CH(CH₃)O]ₐ[CH₂CH₂O]_{b}[CH₂CH(OH)R²] Formula (I);

wherein R¹ is a linear or branched, substituted or unsubstituted, alkyl, aryl, alkenyl, alkynyl, cycloalkyl, arylalkyl, or heteroaryl group having from 2 to 18 carbon atoms; R² is a linear or branched aliphatic hydrocarbon radical having from 2 to 26 carbon atoms; a is an number having an average value of from 0.5 to 5, or a value of 1, 2, 3, 4, or 5; and b is an integer having a value of from 10 to 50, 10 to 25, 15 to 45, 15 to 40, 20 to 50, 20 to 40, or 30 to 50.

In one embodiment, the surfactant includes at least 10 carbon atoms in a terminal epoxide unit. Non-limiting embodiments include BASF Corporation's Plurafac SLF-18B45 and Plurafac SLF 180 nonionic surfactants, and also those nonionic surfactants described in U.S. Pat. Nos. 5,766,371 and 5,576,281, each of which is expressly incorporated herein by reference in one or more non-limiting embodiments.

In various embodiments, the surfactant has a Draves wetting time of less than 360 seconds, less than 200 seconds, less than 100 seconds or less than 60 seconds as measured by the Draves wetting method (standard method ISO 8022 using the following conditions; 3-g hook, 5-g cotton skein, 0.1% by weight aqueous solution at a temperature of 25° C.).

In other embodiments, the surfactant is an anionic surfactant. Anionic surfactants are surfactants having in their molecular structure both a hydrophobic hydrocarbon group and also a hydrophilic group, i.e. a water-solubilizing group such as a carboxylate, a sulfonate or a sulfate group or their corresponding acid form. The anionic surfactants typically include an alkali metal (e.g. sodium and potassium) and/or a nitrogen base (e.g. mono-amine or polyamine) salt of a water-soluble alkyl/aryl ether sulfate, alkyl/aryl sulfonate, or alkyl/aryl sulfate. Anionic surfactants may also include fatty acid or fatty acid soaps.

One suitable class of anionic surfactants includes mono-anionic surfactants, such as alkali metal, ammonium or alkanolamine salts of alkyl/aryl sulfonates, alkali metal, ammonium or alkanolamine salts of alkyl sulfates, and mono-anionic polyamine salts. The alkyl sulfates may include alkyl groups having 8 to 26 carbon atoms, such as from 12 to 22 carbon atoms or 14 to 18 carbon atoms. The alkyl/aryl sulfonates may include alkyl group having 8 to 16 carbon atoms, such as from 10 to 15 carbon atoms. In certain embodiments, the alkyl/aryl sulfonate is a sodium, potassium or ethanolamine salt of a C₁₀ to C₁₆ benzene sulfonate, such as sodium linear dodecyl benzene sulfonate. The alkyl sulfates can be made by reacting long chain olefins with sulfites or bisulfites, e.g. sodium bisulfite. The alkyl sulfonates can also be made by reacting long chain normal paraffin hydrocarbons with sulfur dioxide and oxygen as described in, for example, U.S. Pat. Nos. 2,503,280, 2,507,088, 3,372,188 and 3,260,741, each of which is expressly incorporated herein by reference in one or more non-limiting embodiments, to obtain normal or secondary higher alkyl sulfates suitable for use as surfactants. The anionic surfactant may include an alkyl substituent that is linear, (e.g. alkyl sulfonates), or branched (e.g. branched chain alkyl sulfonates). The alkyl, i.e., alkane, substituent may be terminally sulfonated or may be joined, for example, to the 2-carbon atom of the chain, i.e. may be a secondary sulfonate. It is understood in the art that the substituent may be joined to any carbon on the alkyl chain. The alkyl sulfonates can be used as alkali metal salts, such as salts including sodium and potassium.

Another suitable class of anionic surfactants includes alkyl polyalkoxy sulfates, such as alkyl polyethoxy sulfates. The alkyl polyalkoxy sulfates may include linear or branched chain alkyl groups, and/or include alkoxy groups with two or three carbon atoms. The alkyl polyalkoxy sulfates may be one or more surfactants having a structure according to Formula (II):

R³O[(CH₂)_{c}CH₂CH₂O]_{d}SO₃M Formula (II);

wherein R³ is a C₈ to C₂₀ alkyl, such as C₁₀ to C₁₈, or C₁₂ to C₁₅; c is an integer having a value of from 1 to 8, such as from 2 to 6, or 2 to 4; d is an integer having a value of 0, 1, 2, or 3; and M is an alkali metal such as sodium or potassium, an ammonium cation, or polyamine. In certain embodiments, the alkyl poly ethoxylated sulfate is a sodium salt of a triethoxy C₁₂ to C₁₅ alcohol sulfate having the formula: C₁₂₋₁₅O(CH₂CH₂O)₃SO₃Na. In other embodiments, the alkyl poly alkoxy sulfates can be used in combination with each other and/or in combination with the above discussed higher alkyl benzene, sulfonates, or alkyl sulfates.

Suitable classes of alkyl polyethoxy sulfates include alkyl ethoxy sulfates, such as C₁₂ to C₁₅ linear and primary alkyl triethoxy sulfate sodium salts; n-decyl diethoxy sulfate sodium salts; C₁₂ primary alkyl diethoxy sulfate ammonium salts; C₁₂ primary alkyl triethoxy sulfate sodium salts; C₁₅ primary alkyl tetraethoxy sulfate sodium salts; mixed C₁₄/C₁₅ linear primary alkyl mixed tri- and tetraethoxy sulfate sodium salts; stearyl pentaethoxy sulfate sodium salts; and mixed C₁₀ to C₁₈ linear primary alkyl triethoxy sulfate potassium salts.

In various embodiments the surfactant is or includes a cationic surfactant. Some examples of suitable cationic surfactants are quaternary ammonium salts having a structure according to Formula (III):

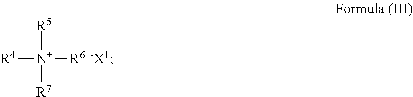

wherein R⁴, is a C₄ to C₂₁ hydrocarbon chain, such as an alkyl, hydroxyalkyl or ethoxylated alkyl group, optionally substituted with a heteroatom, an ester group, or an amide group; each of R⁵, R⁶, and R⁷, which may be the same or different, is independently a C₁ to C₅ alkyl or substituted alkyl group; and ⁻X¹ is a solubilizing anion such as chloride, bromide, a sulfate ion, a phosphate ion, or combinations thereof. In certain embodiments, the cationic surfactant is a quaternary ammonium compound of Formula (III) above, wherein R⁴ is a C₈ to C₁₈ alkyl group, more preferably a C₈ to C₁₀ or C₁₂ to C₁₄ alkyl group, R⁵ is a methyl group, and R⁶ and R⁷, which may be the same or different, are methyl or hydroxyethyl groups. In various embodiments, the cationic surfactant is a compound of Formula (III) above where R⁴ is a C₁₂ to C₁₄ alkyl group, R⁵ and R⁶ are methyl groups, R⁷ is a 2-hydroxyethyl group, and ⁻X¹ is a chloride ion. This cationic surfactant is commercially available as Praepagen (Trademark) HY from Clariant GmbH.

Other examples of suitable cationic surfactants include ethoxylated quaternary ammonium compounds, such as those having structures according to Formula (IV):

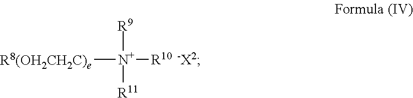

wherein R⁸ is a C₆-C₂₀ alkyl group; e is an integer having a value of from 1 to 20; R⁹ and R¹⁰, which may be the same or different, are each independently a C₁ to C₄ alkyl group or a C₂ to C₄ hydroxyalkyl group; R¹¹ is a C₁ to C₄ alkyl group; and ⁻X² is a monovalent solubilizing anion. In some embodiments the cationic surfactant is a compound of Formula (IV) above where R⁸ is a C₁₀ to C₁₆ alkyl group; e is an integer having a value of 1, 2, 3, or 4; R⁹, R¹⁰, and R¹¹ are methyl groups; and ⁻X² is Cl⁻. In other embodiments, the cationic surfactant is a compound of Formula (IV) above where R⁸ is a C₁₂ to C₁₄ alkyl group; e is 3, R⁹, R¹⁰, and R¹¹ are methyl groups; and ⁻X² is Cl⁻. Other classes of suitable cationic surfactant include cationic esters (for example, choline esters).

In some embodiments the surfactant is or includes a zwitterionic surfactant. The zwitterionic surfactant may be an amine oxide, such as linear and branched compounds having a structure according to Formula (V):

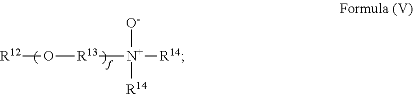

wherein R¹² is a C₂ to C₂₆ alkyl, hydroxyalkyl, acylamidopropoyl, alkyl phenyl group, or combinations thereof; R¹³ is a C₂-C₆ alkylene or hydroxyalkylene group or combinations thereof; f is an integer having a value of 1, 2, 3, 4, or 5; and each R¹⁴ is independently a C₂ to C₆ alkyl or hydroxyalkyl group, or a polyethylene oxide group including from 1, 2, 3, 4, or 5 ethylene oxide group. The R¹⁴ groups may be attached to each other, e.g., through an oxygen or nitrogen atom, to form a cyclic structure.

The surfactant can be present in an amount of from 0 to 100, 1 to 99, 5 to 95, 10 to 90, 20 to 80, 30 to 90, 40 to 95, 50 to 100, 60 to 99, 75 to 100, 90 to 99, 90 to 95, or 95 to 100 parts by weight per 100 parts by weight of the detergent. In certain embodiments the surfactant is present in at least 80, at least 90, at least 95, or at least 99 parts by weight per 100 parts by weight of the detergent. All values and ranges of values therebetween are also expressly contemplated herein in various non-limiting embodiments.

In various embodiments, the surfactant is present in an amount of from 20 to 80 parts by weight per 100 parts by weight of the core cleaning composition. For example, the detergent may include the surfactant in an amount of from 20 to 75, 25 to 75, 25 to 70, 30 to 70, 30 to 80, 30 to 75, 35 to 65, 30 to 60, 25 to 50, 45 to 70, 45 to 55, or 50 to 60 parts by weight per 100 parts by weight of the core cleaning composition. All values and ranges of values therebetween are also expressly contemplated herein in various non-limiting embodiments.

The surfactant is not limited to a single chemical compound. As such, in some embodiments, the surfactant includes more than one surfactant compounds such as a primary surfactant compound, a secondary surfactant compound, or any combination thereof. In some embodiments 2 to 10 surfactant compounds, such as 2, 3, 4, 5, 6, 7, 8, 9, or 10 surfactant compounds are used. For example, the surfactant may include a primary surfactant compound and 2 to 9 secondary surfactant compounds, 2 primary surfactant compounds and 3 to 8 secondary surfactant compounds, 3 primary surfactant compounds and 4 to 7 secondary surfactant compounds. In other embodiments, more than 10 surfactant compounds are used. In certain embodiments, the surfactant is a mixture of alkyl benzene sulfonates and alkyl sulfates, a mixture of alkyl benzene sulfonates and alkyl polyether sulfates. For example, the surfactant may be an admixture of an alkali metal or ethanolamine sulfate with an alkylbenzene sulfonate. In certain embodiments, the surfactant includes both a primary surfactant and a primary surfactant modifier, such as monoethanolamine (MEA). In other embodiments, the surfactant is a mixture of primary surfactants, secondary surfactants, and a surfactant modifier such as monoethanolamine (MEA).

### Detergent Additives:

In various embodiments the detergent includes or is one or more additives selected from soaps, peroxyacid and persalt bleaches, bleach activators, air bleach catalysts, sequestrants, cellulose ethers and esters, cellulosic polymers, antiredeposition agents, sodium chloride, calcium chloride, sodium bicarbonate, other inorganic salts, fluorescers, fluorescent whitening agents, shading dyes, photobleaches, polyvinyl pyrrolidone, other dye transfer inhibiting polymers, foam controllers, foam boosters, acrylic and acrylic/maleic polymers, proteases, lipases, cellulases, amylases, mannanases, pectinases, and other detergent enzymes, citric acid, soil release polymers, silicone, fabric conditioning compounds, colored speckles and other inert additives, and perfumes.

### Solvent System:

The solvent system includes an ionic liquid and water. Each is described in greater detail below.

The solvent system can be present in the core cleaning composition in an amount of from 25 to 65, such as from 25 to 60, 30 to 65, 30 to 60, 30 to 55, 35 to 60, 35 to 56, 30 to 50, 35 to 50, and 40 to 56, parts by weight per 100 parts by weight of the core cleaning composition. All values and ranges of values therebetween are also expressly contemplated herein in various non-limiting embodiments.

### Ionic Liquid:

The ionic liquid is typically a salt that has a melting temperature of 100, 95, 90, 85, 80, 75, 70, 65, 60, 55, 50, 45, 40, 35, 30, or 25° C., or less, or, in alternative embodiments, has a melting temperature of 60, 55, 50, or 45, ° C. or less, or, in yet other alternative embodiments, has a melting temperature of 40, 35, or 30, ° C. or less. In another embodiment, the ionic liquid is a salt that is liquid at room temperature, e.g. 25° C. In other embodiments, the ionic liquid exhibits no discernible melting point (e.g. based on DSC analysis) but is “flowable” at a temperature of 100, 95, 90, 85, 80, 75, 70, 65, 60, 55, 50, 45, 40, 35, 30, or 25, ° C. or below, or, in other embodiments, is “flowable” at a temperature of from 20° C. to 80° C., from 25° C. to 75° C., from 30° C. to 70° C., from 35° C. to 65° C., from 40° C. to 60° C., from 45° C. to 55° C., or from 50° C. to 55° C. In various embodiments, the term “flowable” and/or the term “liquid” describes that the ionic liquid exhibits a viscosity of less than 10,000, 9,000, 8,000, 7,000, 6,000, 5,000, 4,000, 3,000, 2,000, or 1,000, mPa·s at the temperatures described above. The viscosities of the ionic fluids can be measured on a Brookfield viscometer model number LVDVII+ at 20° C., with spindle no. S31 at the appropriate speed to measure materials of different viscosities. The sample can be pre-conditioned by storing the ionic liquids in a desiccator including a desiccant (e.g. calcium chloride) at room temperature for at least 48 hours prior to the viscosity measurement. This equilibration period unifies the amount of innate water in the ionic liquid samples. All values and ranges of values between and including the aforementioned values are hereby expressly contemplated in various non-limiting embodiments.

The terms “ionic liquid”, “ionic compound”, and “IL” may describe ionic liquids, ionic liquid composites, and combinations of ionic liquids. The ionic liquid can include an anionic IL component and a cationic IL component. When the ionic liquid is in a liquid form, these components may freely associate with one another. In one embodiment, the disclosure provides a mixture of two or more, typically at least three, different and charged IL components, wherein at least one IL component is cationic and at least one IL component is anionic. Thus, the pairing of three cationic and anionic IL components in a mixture could result in at least two different ionic liquids. The combinations of ionic liquids may be prepared either by mixing individual ionic liquids having different IL components, or by preparing them via combinatorial chemistry. Such combinations and their preparation are described in further detail in US 2004/0077519A1 and US 2004/0097755A1, each of which is expressly incorporated herein by reference in one or more non-limiting embodiments. As used herein, the term “ionic liquid composite” typically describes a mixture of a salt (which can be solid at room temperature) with a proton donor Z (which can be a liquid or a solid) as described in the references set forth immediately above. Upon mixing, these components may turn into a liquid at 100° C. or less, and the mixture typically behaves like an ionic liquid. These mixtures can include Deep Eutectic Solvents (DESs), in which one or more compounds are mixed to form a eutectic with a melting point much lower than the melting points of the individual components. One non-limiting example is choline chloride (MP 302° C.) plus urea (MP 133° C.) mixed in a 1:2 molar ratio to form a DES (MP 12° C.).

In various embodiments, the ionic liquids suitable for use herein may have, or be, various anion and cation combinations. The anions and cations can be adjusted and mixed such that properties of the ionic liquids can be customized for specific applications, so as to provide the desired solvating properties, viscosity, melting point, and other properties, as desired. Non-limiting examples of ionic liquids that may be used herein are described in U.S. Pat. Nos. 6,048,388 and 5,827,602; U.S. Pat. App. Pub. Nos. 2003/915735, 2004/0007693A1, 2004/003120, and 2004/0035293; and PCT Pub. Nos. WO 02/26701, WO 03/074494, WO 03/022812, and WO 04/016570, each of which is expressly incorporated herein by reference in one or more non-limiting embodiments. In other embodiments, one or more of the following anions and cations can be utilized.

### Ionic Liquid Anions:

Alkyl sulfates (AS), alkoxy sulfates and alkyl alkoxy sulfates, wherein the alkyl or alkoxy is methyl, linear, branched, or combinations thereof, can be utilized. Furthermore, the attachment of the sulfate group to the alkyl chain can be terminal on the alkyl chain (AS), internal on the alkyl chain (SAS) or combinations thereof. Non-limiting examples include linear C₁ to C₂₀ alkyl sulfates having a structure according to Formula (VI):

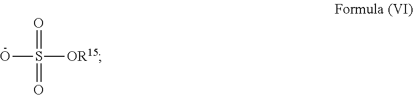

wherein R¹⁵ is an alkyl group having from 1 to 20 carbon atoms, such as 1, 2, 3, 4, 5, or 6, or from 1 to 15, 2 to 12, 3 to 10, or 5 to 20 carbon atoms. In some embodiments the cation is methyl sulfate. Other suitable examples of anions include linear C₃ to C₂₀ secondary alkyl sulfates having a structure according to Formula (VII):

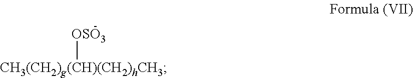

wherein g+h is an integer having a value of from 0 to 17, such as 0, 1, 2, 3, 4, 5, 6, 7, 8, 9, 10, 11, 12, 13, 14, 15, 16, or 17. Further examples of suitable anions include C₅ to C₅₅ secondary alkyl ethoxy sulfates having a structure according to Formula (VIII):

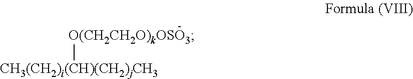

wherein i+j is an integer having a value of from 0 to 18, such as 0, 1, 2, 3, 4, 5, 6, 7, 8, 9, 10, 11, 12, 13, 14, 15, 16, 17, or 18; and k is an integer having a value of from 1 to 31, such as from 1 to 25, 5 to 10, 10 to 20, 5 to 25, or 2 to 12. Non-limiting examples of alkoxy sulfates include sulfated derivatives of commercially available alkoxy copolymers, such as Pluronics® (from BASF).

Mono- and di-esters of sulfosuccinates may also be used. Non-limiting examples include saturated and unsaturated C₁₂ to C₁₈ monoester sulfosuccinates, such as lauryl sulfosuccinate available as Mackanate LO-100® (from The McIntyre Group); saturated and unsaturated C₆ to C₁₂ diester sulfosuccinates, such as dioctyl ester sulfosuccinate available as Aerosol OT® (from Cytec Industries, Inc.). Methyl ester sulfonates (MES) can also be utilized.

Alkyl aryl sulfonates can alternatively be utilized. Non-limiting examples include tosylate, alkyl aryl sulfonates having linear or branched, saturated or unsaturated C₈ to C₁₄ alkyls; alkyl benzene sulfonates (LAS) such as C₁₁ to C₁₈ alkyl benzene sulfonates; sulfonates of benzene, cumene, toluene, xylene, t-butyl benzene, di-isopropyl benzene, or isopropyl benzene; naphthalene sulfonates and C₆ to C₁₄ alkyl naphthalene sulfonates, such as Petro® (from Akzo Nobel Surface Chemistry); sulfonates of petroleum, such as Monalube 605° (from Uniqema). Non-limiting examples further include:

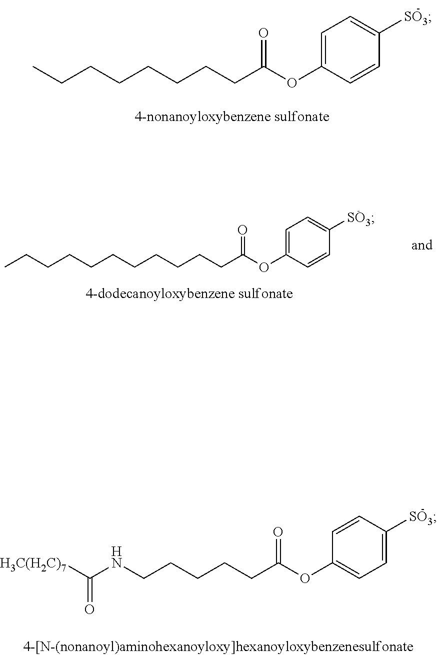

which are disclosed in U.S. Pat. Nos. 5,891,838; 6,448,430; 5,891,838; 6,159,919; 6,448,430; 5,843,879; and 6,548,467, each of which is expressly incorporated herein by reference in one or more non-limiting embodiments.

Alkyl glycerol ether sulfonates having 8 to 22 carbon atoms in the alkyl group can also be utilized. Moreover, diphenyl ether (bis-phenyl) derivatives can be used. Non-limiting examples include triclosan (2,4,4′-trichloro-2′-hydroxydiphenyl ether) and diclosan (4,4′-dichloro-2-hydroxydiphenyl ether), both are available as Irgasan® from BASF Corporation.

Linear or cyclic carboxylates can be used as well. Non-limiting examples include citrate, lactate, tartarate, succinate, alkylene succinate, maleate, gluconate, formate, cinnamate, benzoate, acetate, salicylate, phthalate, aspartate, adipate, acetyl salicylate, 3-methyl salicylate, 4-hydroxy isophthalate, dihydroxyfumarate, 1,2,4-benzene tricarboxylate, pentanoate and combinations thereof. Other examples of suitable anions include alkyl oxyalkylene carboxylates, such as C₁₀ to C₁₈ alkyl alkoxy carboxylates including 1-5 ethoxy units. Further examples include alkyl diphenyl oxide monosulfonates, such as those having a structure according to Formula (IX):

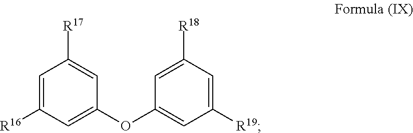

wherein each of R¹⁶ and R¹⁹ is H or a C₁₀ to C₁₈ linear or branched alkyl group; at least one of R¹⁷ and R¹⁸ is SO₃⁻; and the other of R¹⁷ and R¹⁸ is SO₃⁻ or H. Suitable alkyl diphenyl oxide monosulfonates are available as DOWFAX® from Dow Chemical and as POLY-TERGENT® from Olin Corp.

Mid-chain branched alkyl sulfates (HSAS), mid-chain branched alkyl aryl sulfonates (MLAS) and mid-chain branched alkyl polyoxyalkylene sulfates can also be used. Non-limiting examples of MLAS are disclosed in U.S. Pat. Nos. 6,596,680; 6,593,285; and 6,202,303, each of which is expressly incorporated herein by reference in one or more non-limiting embodiments.

Suitable examples may also include alpha olefin sulfonates (AOS) and paraffin sulfonates, such as C₁₀ to C₂₂ alpha-olefin sulfonates, available as Bio Terge AS-40® from Stepan Company. Further suitable examples may include alkyl phosphate esters, such as C⁸ to C²² alkyl phosphates, available as Emphos CS® and Emphos TS-230® from Akzo Nobel Surface Chemistry LLC. Some examples of suitable anions include sarcosinates having a structure according to Formula (X):

R²⁰CON(CH₃)CH₂CŌ₂ Formula (X);

wherein R²⁰ is a C₈ to C₂₀ alkyl group. Non-limiting examples include ammonium lauroyl sarcosinate, available as Hamposyl AL-30® from Dow Chemicals and sodium oleoyl sarcosinate, available as Hamposyl O® from Dow Chemical. Additionally, suitable examples may include taurates, such as C₈ to C₂₂ alkyl taurates, available as sodium coco methyl tauride or Geropon TC® from Rhodia, Inc.

Further examples of suitable anions include sulfated and sulfonated oils and fatty acids, linear or branched, such as those sulfates or sulfonates derived from potassium coconut oil soap available as Norfox 1101° from Norman, Fox & Co. and Potassium oleate from Chemron Corp. can also be used. Fatty acid ester sulfonates can also be used, such as those having a structure according to Formula (XI):

R²¹CH(SŌ₃)CO₂R²² Formula (XI)

wherein R²¹ is linear or branched C₈ to C₁₈ alkyl, and R²² is linear or branched C₁ to C₆ alkyl group. Other examples of anions that can be used include alkyl phenol ethoxy sulfates and sulfonates, such as C₈ to C₁₄ alkyl phenol ethoxy sulfates and sulfonates, such as sulfated nonylphenol ethoxylate available as Triton XN-45S® from Dow Chemical.

Substituted salicylanilide anions can also be used, such as those having a structure according to Formulas (XII) and (XIII):

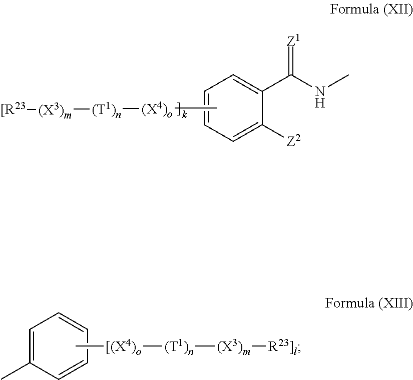

wherein k is an integer having a value of from 0 to 4; 1 is an integer having a value of from 0 to 5; m is an integer having a value of 0 or 1; n is an integer having a value of 0 or 1; o is an integer having a value of 0 or 1; Z¹ and Z² are independently O or S; X³ and X⁴, when present, are 0, S, or a nitrogen atom substituted with H, a C₁ to C₁₆ linear or branched, substituted or unsubstituted alkyl, alkenyl, alkynyl, cycloalkyl, cycloalkenyl, alkaryl, or aryl group; T¹, when present, is C═O, C═S, S═O, or SO₂; and R²³ is H, a C₁ to C₁₆ linear or branched, substituted or unsubstituted alkyl, alkenyl, alkynyl, cycloalkyl, cycloalkenyl, alkaryl, or aryl group, F, Cl, Br, I, CN, NO₂, or a NO group substituted with a C₁ to C₁₆ linear or branched, substituted or unsubstituted, alkyl, alkenyl, alkynyl, cycloalkyl, cycloalkenyl, alkaryl, or aryl group. Derivatized substituted salicylanilide anions, wherein one or both aromatic rings include additional substituents, are also suitable for use herein. Substituted salicylanilide and derivatives thereof are disclosed in US 2002/0068014A1 and WO 04/026821, each of which is expressly incorporated herein by reference in one or more non-limiting embodiments.

Substituted phenol and thiophenol anions also be used, such as those having a structure according to Formula (XIX):

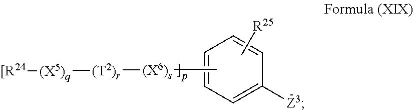

wherein p is an integer having a value of from 0 to 4; q is an integer having a value of 0 or 1; r is an integer having a value of 0 or 1; s is an integer having a value of 0 or 1; Z is O or S; X⁵ and X⁶, when present, are independently O, S, or a nitrogen atom substituted with H, a C₁ to C₁₆ linear or branched, substituted or unsubstituted alkyl, an alkenyl, alkynyl, cycloalkyl, cycloalkenyl, alkaryl, or aryl group; R²⁴ is H, a C₁ to C₁₆ linear or branched, substituted or unsubstituted, alkyl, alkenyl, alkynyl, cycloalkyl, cycloalkenyl, alkaryl, or aryl group, F, Cl, Br, I, CN, NO₂, or a NO group substituted with a C₁ to C₁₆ linear or branched, substituted or unsubstituted, alkyl, alkenyl, alkynyl, cycloalkyl, cycloalkenyl, alkaryl, or aryl group; T², when present, is C═O, C═S, S═O, or SO₂; and R²⁵ is a C₁ to C₂₀ linear or branched, substituted or unsubstituted, alkyl, alkenyl, alkynyl, cycloalkyl, cycloalkenyl, alkaryl, or aryl group that is optionally substituted with O, S, or N. Suitable substituted phenol and thiophenol anions are disclosed in US 2002/0068014A1 and WO 04/026821, each of which is expressly incorporated herein by reference in one or more non-limiting embodiments.

Polyamino polycarboxylates can also be used. Non-limiting examples include ethylene ethylenediamine tetraacetate (EDTA), diamine tetraacetates, N-hydroxy ethyl ethylene diamine triacetates, nitrilo-tri-acetates, ethylenediamine tetraproprionates, triethylene tetraamine hexaacetates, diethylene triamine pentaacetates, and ethanol diglycines. Other suitable anions in include aminopolyphosphonates, such as ethylenediamine tetramethylene phosphonate and diethylene triamine pentamethylene-phosphonate. Sweetener derived anions such as saccharinate and acesulfamate can also be used.

In addition, ethoxylated amide sulfates; sodium tripolyphosphate (STPP); dihydrogen phosphate; fluroalkyl sulfonate; bis-(alkylsulfonyl) amine; bis-(fluoroalkylsulfonyl)amide; (fluroalkylsulfonyl)(fluoroalkylcarbonyl)amide; bis(arylsulfonyl)amide; carbonate; tetrafluorborate (BF₄⁻); and hexafluorophosphate (PF₆⁻) can be used. Anionic bleach activators can also be used, including those disclosed in U.S. Pat. Nos. 5,891,838; 6,448,430; 5,891,838; 6,159,919; 6,448,430; 5,843,879; and 6,548,467, each of which is expressly incorporated herein by reference in one or more non-limiting embodiments.

In further embodiments, the anion may be a monoatomic atom, such as F⁻, Cl⁻, Br⁻, and I⁻. In some embodiments the anion is a polyatomic ion such as NO₃⁻, PF₆⁻, or BF₄⁻.

### Ionic Liquid Cations:

Cations suitable for use in the ionic liquids of the present disclosure include, but are not limited to, the following. It is to be appreciated that a combination of the cations described below may also be used.

Cations (i.e., the protonated, cationic form) of amine oxides, phosphine oxides, and sulfoxides can be used. Non-limiting examples include amine oxide cations substituted with C₁ to C₁₈ alkyl groups, such as C₁ to C₅ alkyl groups and C₁ to C₅ hydroxyalkyl groups; phosphine oxide cations including cations substituted with C₁ to C₁₈ alkyl groups, such as C₁ to C₅ alkyl groups and C₁ to C₅ hydroxyalkyl groups; and sulfoxide cations including cations including C₁ to C₁₈ alkyl groups, such as C₁ to C₅ alkyl groups and C₁ to C₅ hydroxyalkyl groups.

The cation may be an ammonium cation, such as those having a structure according to Formula (XX):

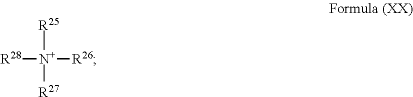

wherein each of R²⁵-R²⁸, which can be the same or different, is independently a methyl, or a linear or branched C₁ to C₂₀ alkyl, aryl, hydroxylalkyl, alkylether, or alkylaryl group. In some embodiments at least one, at least two, or at least three of R²⁵-R²⁸ are the same. In certain embodiments, at least one of R²⁵-R²⁸ is a C₁ to C₅ alkyl group, such as a methyl, ethyl, propyl, isopropyl, butyl, isobutyl, secbutyl, tertbutyl, or pentyl group, and at least one other of R²⁵-R²⁸ is a hydroxyalkyl group, such as a hydroxymethyl, hydroxyethyl, hydroxypropyl, hydroxybutyl, or hydroxypentyl group. In some embodiments R²⁵-R²⁷ are each a 2-hydroxyethyl group and R²⁸ is a methyl group, such that the cation is tris(2-hydroxyethyl)methyl ammonium.

Other suitable cations include amine oxides, such as those having a structure according to Formula (XXI):

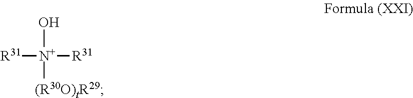

wherein R²⁹ is a linear or branched, substituted or unsubstituted, C₈ to C₂₂ alkyl, hydroxyalkyl, or alkylaryl group; R³⁰ is a C₂ to C₃ alkylene or hydroxyalkylene group, or combinations thereof; t is an integer having a value of from 0 to 3; and each of R³¹ is independently an C₁ to C₅ alkyl or hydroxyalkyl group, or a polyalkylene oxide group, such as propylene or ethylene oxide, with an average of from 1 to 3 alkylene oxide groups. The R³¹ groups may be attached to each other, e.g., directly or through an oxygen or nitrogen atom, to form a cyclic structure. Other amine oxide cations including C₁₀ to C₁₈, C₁₀, C₁₀ to C₁₂, and C₁₂ to C₁₄ alkyl dimethyl amine oxide cations, and C₈ to C₁₂ alkoxy ethyl dihydroxy ethyl amine oxide cations can also be used.

Betaines can also be used as the cation, such as those having a structure according to Formula (XXII):

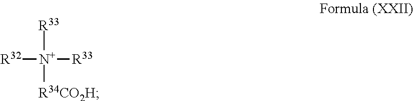

wherein R³² is a linear or branched, substituted or unsubstituted, C₁₀ to C₂₂ alkyl, alkyl aryl, or aryl alkyl group, optionally interrupted by amido or ether linkages; wherein each R₁ is an alkyl group including from 1 to 3 carbon atoms; and R₂ is an alkylene group including from 1 to 6 carbon atoms. Non-limiting examples of betaines include dodecyl dimethyl betaine, acetyl dimethyl betaine, dodecyl amidopropyl dimethyl betaine, tetradecyl dimethyl betaine, tetradecyl amidopropyl dimethyl betaine, dodecyl dimethyl ammonium hexanoate; and amidoalkylbetaines which are disclosed in U.S. Pat. Nos. 3,950,417; 4,137,191; and 4,375,421; and GB Pat. No. 2,103,236. In another embodiment, the cation may be a sulfobetaine, which are disclosed in U.S. Pat. No. 4,687,602. Each of the aforementioned documents is expressly incorporated herein by reference in one or more non-limiting embodiments.

Diester quaternary ammonium (DEQA) cations can also be used, such as those substituted with hydrogen, linear or branched, substituted or unsubstituted, C₁ to C₂₀ alkyl or hydroxyalkyl groups such as methyl, ethyl, propyl, and hydroxyethyl groups, poly(C₁ to C₃ alkoxy) groups such as polyethoxy groups, benzyl groups, or combinations thereof. In some embodiments the DEQA cation is [CH₃]₃N⁺[CH₂CH(CH₂OC(O)(C₁₅₋₁₉)OC(O)(C₁₅₋₁₉)], wherein each C₁₅₋₁₉ is independently a linear or branched, substituted or unsubstituted, C₁ to C₂₀ alkyl, hydroxyalkyl, poly(C₁ to C₃ alkoxy), or benzyl group, or any combination thereof. Other DEQA cations include alkyl dimethyl hydroxyethyl quaternary ammonium cations, such as those described in U.S. Pat. No. 6,004,922, which is expressly incorporated herein by reference in one or more non-limiting embodiments. Cationic esters such as those described in U.S. Pat. Nos. 4,228,042, 4,239,660, 4,260,529, and 6,022,844, can also be used. Each of these documents is expressly incorporated herein by reference in one or more non-limiting embodiments.

Suitable cations can also be alkylene quaternary ammonium cations, such as those having a structure according to Formula (XXIII):

(R³⁵₄₋ᵤN⁺R³⁶)ᵤ Formula (XXIII);

wherein each of R³⁵ is independently a linear or branched, saturated or unsaturated, substituted or unsubstituted, C₆ to C₂₂ alkyl, alkenyl, aryl, alkaryl, or alkoxy group, or a combination thereof each R³⁶ is independently a linear or branched, saturated or unsaturated, substituted or unsubstituted, C₆ to C₂₂ alkenyl group, or a combination thereof and each u is an integer having a value of 1, 2, 3, or 4. In one embodiment, the cation is dialkylenedimethyl ammonium, such as dioleyldimethyl ammonium available from Witco Corporation under the tradename Adogen® 472. In another embodiment, the cation is monoalkenyltrimethyl ammonium, such as monooleyltrimethyl ammonium, monocanolatrimethyl ammonium, and soyatrimethyl ammonium. In some embodiments, alkyl oxyalkylene cations and alkoxylate quaternary ammoniums (AQA) can be used, such as those described in U.S. Pat. No. 6,136,769, expressly incorporated herein in one or more non-limiting embodiments.

Cations such as di-fatty amido quaternary ammonium cations can also be used. Specific, non-limiting examples of suitable di-fatty amido quaternary ammonium cations may include those having a structure according to Formula (XXIV):

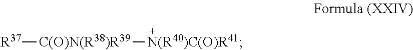

wherein each of R³⁷-R⁴¹ is independently a linear or branched, saturated or unsaturated, substituted or unsubstituted, C₆ to C₂₂ alkyl, alkenyl, aryl, alkaryl, or alkoxy group, or a combination thereof.

Other suitable cations include C₈ to C₂₂ quaternary surfactants such as isostearyl ethyl imidonium, which is available commercially from Scher Chemicals, Inc. as an ethosulfate salt under the trade name Schercoquat IIS®, quaternium-52, which is available commercially from Cognis Corporation under the trade name Dehyquart SP®, and dicoco dimethyl ammonium, which is commercially available from Akzo Nobel Surface Chemistry LLC as a chloride salt under the trade name Arquad 2C-75®.

Other cations including 4,5-dichloro-2-n-octyl-3-isothiazolone, which is obtainable as Kathon® from Rohm and Haas, and quaternary amino polyoxyalkylene derivatives (e.g. choline and choline derivatives) can also be utilized. Further examples of suitable cations can include substituted and unsubstituted pyrrolidinium, imidazolium, benzimidazolium, pyrazolium, benzpyrazolium, thiazolium, benzthiazolium, oxazolium, benzoxazolium, isoxazolium, isothiazolium, imdazolidenium, guanidinium, indazolium, quinuclidinium, triazolium, isoquinuclidinium, piperidinium, morpholinium, pyridazinium, pyrazinium, triazinium, azepinium, diazepinium, pyridinium, piperidonium, pyrimidinium, thiophenium; and phosphonium cations. In some embodiments, the cation is a substituted imidazolium cation, such as 1-methyl-1-oleylamidoethyl-2-oleylimidazolinium, which is available commercially from the Witco Corporation under the trade name Varisoft® 3690.

In other embodiments, the cation is an alkylpyridinium cation having a structure according to Formula (XXV):

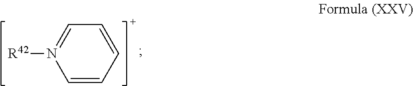

or an alkanamide alkylene pyridinium cation having a structure according to Formula (XXVI):

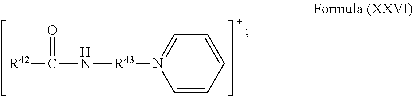

wherein each R⁴² is independently a linear or branched, substituted or unsubstituted, C₆ to C₂₂ alkyl, aryl, alkenyl, alkynyl, cycloalkyl, arylalkyl, or heteroaryl group; and R⁴³ is a C₁ to C₆ alkyl or alkenyl group.

Cationic bleach activators having a quaternary ammonium group can also be used. Suitable examples may include:

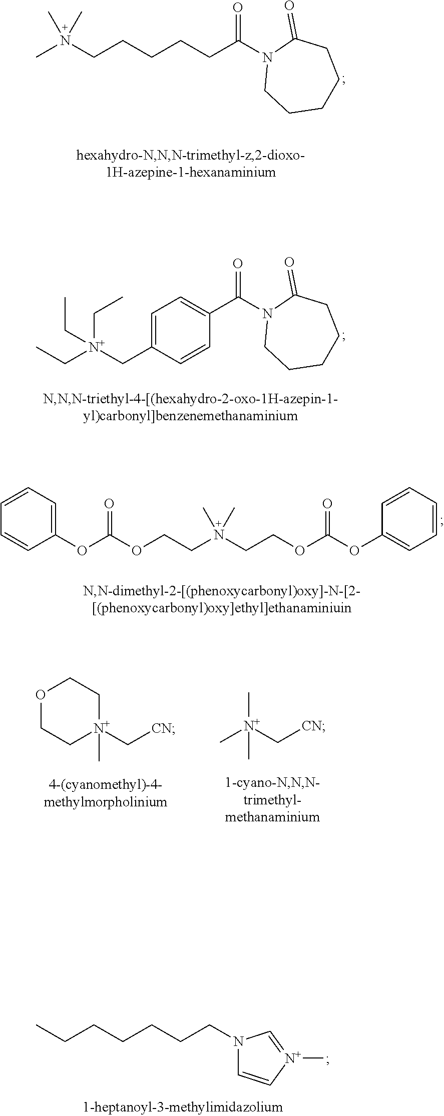

and combinations thereof.

Other cationic bleach activators suitable for use as the cation include 1-methyl-3-(1-oxoheptyl) imidazolium, and also those cationic bleach activators described in U.S. Pat. Nos. 5,106,528; 5,281,361; 5,599,781; 5,686,015; 5,686,015; 5,534,179; and 6,183,665; and also those described in PCT Pub. No. WO 95/29160, European Pub. No. EP 1 253 190 A1, and Bulletin de la Societe Chimique de France (1973), (3)(Pt. 2), 1021-7, each of which is expressly incorporated herein by reference in one or more non-limiting embodiments.

Cationic anti-microbial agents, such as cetyl pyridinium, chlorohexidine and domiphen can also be used. Moreover, alkylated caffeine cations can also be used, including those having a structure according to Formula (XXVII):

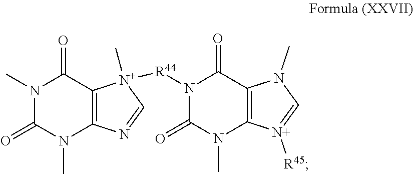

wherein each of R⁴⁴ and R⁴⁵ is independently a C₁ to C₁₂ alkyl or alkylene group, or a combination thereof. Other suitable cations include alkyl polyamino carboxylates, such as those having a structure according to Formula (XXVIII):

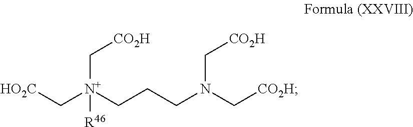

wherein R⁴⁶ is a C₈ to C₂₂ alkyl or alkylene group, or a coco, tallow or oleyl group. Non-limiting examples include the compounds sold under the trade names Ampholak® 7CX/C, Ampholak® 7TX/C, and Ampholak® XO7/C, which are each available commercially from Akzo Nobel.

In some embodiments, the ionic liquid including an anion and cation combination according to Formula (XXIX):

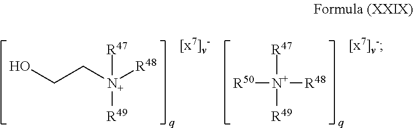

wherein each of R⁴⁷-R⁵⁰ is independently a linear or branched, substituted or unsubstituted, C₁ to C₂₂ alkyl, aryl, alkenyl, alkynyl, cycloalkyl, arylalkyl, heteroaryl, alkoxyalkyl, alkylenearyl, hydroxyalkyl, or haloalkyl group; X is an anion such as those described above; and v and q are each an integer independently having a value chosen to provide electronic neutrality in regards to the anionic and cationic components.

In further embodiments, the ionic liquid includes a cation chosen from trimethyloctyl ammonium cation, triisooctylmethyl ammonium cation, tetrahexyl ammonium cation, tetraoctyl ammonium cation, and combinations thereof, and an anion chosen from those described hereinabove. In yet further embodiments, the ionic liquids include amine oxide cations and an anion chosen from those described hereinabove. In additional embodiments, the ionic liquids include betaine cations and an anion chosen from those described hereinabove.

In various embodiments the ionic liquid includes an alkylsulfate anion and an alkylammonium cation. A non-limiting example of such an ionic liquid is tris(2-hydroxyethyl)methyl ammonium sulfate. In some embodiments the ionic liquid includes or is tris(2-hydroxyethyl)methyl ammonium sulfate.

The ionic liquid may be present in the solvent system in an amount of from 1 to 60 parts by weight per 100 parts by weight of the solvent system. For example, the solvent system may include the ionic liquid in an amount of from 5 to 60, 10 to 55, 15 to 60, 10 to 50, 15 to 55, 15 to 50, 10 to 20, 10 to 40, 20 to 60, 10 to 30, 10 to 35, and 30 to 60 parts by weight per 100 parts by weight of the solvent system. All values and ranges of values therebetween are also expressly contemplated herein in various non-limiting embodiments.

In various embodiments, the ionic liquid is present in the solvent system in an amount of from 1 to 35 parts by weight per 100 parts by weight of the core cleaning composition. For example, the solvent system may include the ionic liquid in an amount of from 1 to 30, 2 to 28, 4 to 29, 4 to 25, 5 to 30, 5 to 25, 10 to 30, 15 to 25, 20 to 30, 1 to 10, and 10 to 20 parts by weight per 100 parts by weight of the core cleaning composition. All values and ranges of values therebetween are also expressly contemplated herein in various non-limiting embodiments.

In an additional embodiment, ionic liquid includes:

a cation having a structure according to the formula

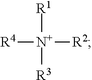

and
an anion having a structure according to the formula

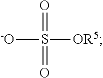

wherein each of R¹-R⁵ is independently a linear or branched C₁-C₁₀ alkyl, aryl, or alkylaryl group and wherein each of R¹-R⁵ is optionally substituted with N, P, S, and O. For example, each one of R¹-R⁵ may be any group that includes N, P, S, or O, e.g. an ether or alcohol group such as an hydroxyethyl group or a polyether group.

### Water:

The water can be any type of water, such as distilled, tap, purified, etc. In various embodiments the water is present in the core cleaning composition in 1 to 50, 5 to 50, 6 to 45, 10 to 35, 15 to 35, 20 to 35, 25 to 35, 30 to 35, 10 to 30, 10 to 25, 15 to 25, or 15 to 20, parts by weight per 100 parts by weight of the core cleaning composition. The water can be present in the solvent system in an amount of from 40 to 90 parts by weight per 100 parts by weight of the solvent system. For example, the solvent system may include the water in an amount of from 45 to 90, 40 to 85, 50 to 90, 45 to 85, 50 to 85, 60 to 90, 40 to 80, 70 to 90, and 40 to 70 parts by weight per 100 parts by weight of the solvent system. All values and ranges of values therebetween are also expressly contemplated herein in various non-limiting embodiments.

The water can be water that is independently added to any one or more components of the composition and/or can be water that is present in one or more of any of the components of the composition. For example, one or more components of the composition may individually have a water content of less than 10 weight percent or more than 50 weight percent but when all of the components are added together the total amount of water present in the composition may be as described above. In various embodiments, e.g. as set forth in the examples, the total amount of water in the composition may be described as total water content (from all sources). All values and ranges of values therebetween are also expressly contemplated herein in various non-limiting embodiments.

### Additional Solvent:

It is to be appreciated that both water and the ionic liquid may be described as solvents. The solvent system optionally includes an additional solvent, i.e., a solvent that is not water or an ionic liquid. The additional solvent is typically an organic solvent. However, it is to be appreciated that the additional solvent may be any type of solvent known in the art. Suitable solvents include alkyl/aryl ethers and polyethers, alkyl/aryl amines, alkyl/aryl amides, alkyl/aryl esters, ketones, aldehydes, alcohols, polyols, glycerides, and combinations thereof.

Examples of suitable solvents may include an alkyleneglycol such as ethylene glycol, propylene glycol, and butylene glycol, or mono or di ethers thereof. Further examples of suitable solvents may include a polyalkylene glycol such as polyethylene glycol, polypropylene glycol, polybutylene glycol, and combinations thereof. The additional solvent may be a polyalkylene glycol reaction product of two or more different alkylene glycols, such as a polyethylene/polypropylene glycol copolymer made from ethylene glycol and propylene glycol. In certain embodiments, the additional solvent is a polyethylene glycol with a weight average molecular weight of from 106 to 600 g/mol. Other examples of suitable additional solvents may include glyme, diglyme, triglyme, or combinations thereof. Further examples of suitable additional solvents include alcohols, such as methanol, ethanol, propyl alcohol, butyl alcohol, and combinations thereof. In various embodiments the additional solvent is 1,3-propanediol, 1-4 butanediol, glycerine, and combinations thereof. In some embodiments, the additional solvent is propylene glycol. In other embodiments, the additional solvent is glycerine. In further embodiments, the additional solvent is propylene glycol, glycerine, ethanol, or combinations thereof. In other embodiments, the additional solvent is a mixture of propylene glycol and glycerin.

The additional solvent can be present in the core cleaning composition in an amount of from 0 to 35, such as from 1 to 30, 5 to 30, 5 to 25, 5 to 20, 10 to 35, 10 to 20, 10 to 25, 10 to 20, 15 to 30, 15 to 25, 15 to 20, or of 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 parts by weight per 100 parts by weight of the core cleaning composition. The additional solvent can be present in the solvent system in an amount of from 0 to 59 parts by weight per 100 parts by weight of the solvent system. For example, the solvent system may include the additional solvent in an amount of from 1 to 58, 2 to 56, 5 to 55, 5 to 50, 10 to 45, 15 to 40, 15 to 35, 20 to 55, 12 to 25, or 45 to 59 parts by weight per 100 parts by weight of the solvent system. All values and ranges of values therebetween are also expressly contemplated herein in various non-limiting embodiments.

### Additional Optional Components:

In various embodiments the core cleaning composition includes one or more additives such as polymers (e.g. acrylic, acrylic/styrene, and acrylic/maleic polymers), chelants, silicates, soaps, peroxyacid and persalt bleaches, bleach activators, air bleach catalysts, sequestrants, cellulose ethers and esters, cellulosic polymers, antiredeposition agents, sodium chloride, calcium chloride, sodium bicarbonate, other inorganic salts, fluorescers, fluorescent whitening agents, photo shaders, photobleaches, polyvinyl pyrrolidone, other dye transfer inhibiting polymers, foam controllers, foam boosters, proteases, lipases, cellulases, amylases, other detergent enzymes, citric acid, soil release polymers, silicone, fabric conditioning compounds, colored speckles and other inert additives, and perfumes.

### Polymer:

The core cleaning composition may include a polymer. The term “polymer” is used herein to describe a chemical compound, or mixture of chemical compounds, formed by reacting together at least two monomers in a polymerization reaction. The term “monomer” is used herein to describe a chemical compound that includes at least one polymerizable functional group (e.g. an alkene). The polymerization reaction may be any reaction known in the art, including, but not limited to: radical polymerizations, such as free-radical polymerization reactions; ionic polymerizations, such as anionic and/or cationic polymerization reactions; coordination polymerization, such as metal and metal-complex mediated polymerization reactions (e.g. Ziegler-Natta-type polymerization reactions). The polymer also includes polymeric compounds which have undergone post-polymerization processing steps, such as, but not limited to, reduction, oxidation, substitution, replacement, ring-opening, ring-forming, and coordination reactions, and combinations thereof. Accordingly, it is to be appreciated that the polymer may be described in terms regarding at least one monomer used to form the polymer, in terms regarding at least one post-polymerization processing step used to form the polymer, in terms regarding at least one functional group present in the polymer, in terms regarding at least one polymeric compound in a mixture of compounds that is the polymer, in terms regarding at least one functional group present in at least one monomer used to form the polymer, in terms regarding at least one compound and/or reaction used in a post-polymerization processing step used to form the polymer, and combinations thereof.

In various embodiments, the polymer is present in an amount from 0.1 to 50, 0.5 to 20, 1 to 15, 2 to 12, or 2.5 to 10 percent by weight based on a total weight of the core cleaning composition. All values and ranges of values therebetween are also expressly contemplated herein in various non-limiting embodiments. In some embodiments the polymer is a mixture of two or more polymeric compounds, such as those described herein.

Suitable non-limiting examples of polymers include sulfonate and/or carboxylate polymers having a weight average molecular weight of less than or equal to 100,000 Da, less than or equal to 75,000 Da, less than or equal to 50,000 Da, from 3,000 Da to 50,000 Da, or from 5,000 Da to 45,000 Da. The sulfonate and/or carboxylate polymers may include at least one structural unit derived from at least one acid-containing monomer having a structure according to Formula (XXX):

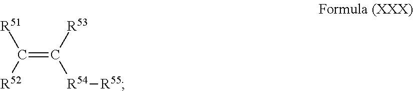

wherein at least one of R⁵¹-R⁵⁵ is, or is substituted with, a carboxylic or sulfonic acid or an ester thereof; and each of the other of R⁵¹-R⁵⁵ is independently a hydrogen atom, or a linear or branched, substituted or unsubstituted, alkyl, aryl, alkenyl, alkynyl, cycloalkyl, arylalkyl, or heteroaryl group; and wherein any carboxylic and/or sulfonic acid groups can be present in neutralized form, i.e., the acidic hydrogen atom of the carboxylic and/or sulfonic acid group in some or all acid groups can be replaced with metal ions, for example alkali metal ions and in particular sodium ions.

Some non-limiting examples of suitable carboxylic acid monomers include one or more of the following: acrylic acids, maleic acids, itaconic acids, methacrylic acids, or ethoxylate esters of acrylic acids. Typical carboxylic acids are acrylic and methacrylic acids. Some non-limiting examples of suitable sulfonated monomers include one or more of the following: sodium (meth)allyl sulfonate, vinyl sulfonate, sodium phenyl(meth)allyl ether sulfonate, or 2-acrylamido-methyl propane sulfonic acid. Some non-limiting examples of suitable non-ionic monomers include one or more of the following: methyl(meth)acrylate, ethyl(meth)acrylate, t-butyl(meth)acrylate, methyl(meth)acrylamide, ethyl(meth)acrylamide, t-butyl(meth)acrylamide, styrene, or alpha-methyl styrene.

In further embodiments, the polymer includes from 40 to 90 or from 60 to 90, weight percent of one or more carboxylic acid monomer; from 5 to 50 or from 10 to 40, weight percent of one or more sulfonic acid monomers; and optionally from 1 to 30 or from 2 to 20, weight percent of one or more non-ionic monomers. In another embodiment, the polymer includes 70 to 80 weight percent of at least one carboxylic acid monomer and from 20 to 30 weight percent of at least one sulfonic acid monomer.

The carboxylic acid may be (meth)acrylic acid. The sulfonic acid monomer is typically one of the following: 2-acrylamido methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzensulfonic acid, 2-hydroxy-3-(2-propenyloxy)propanesulfonic acid, 2-methyl-2-propene-1-sulfonic acid, styrene sulfonic acid, vinylsulfonic acid, 3-sulfopropyl acrylate, 3-sulfopropyl methacrylate, sulfomethylacrylamid, sulfomethylmethacrylamide, and water-soluble salts thereof. The unsaturated sulfonic acid monomer is, in one embodiment, 2-acrylamido-2-propanesulfonic acid (AMPS).

In some embodiments, the polymer is a salt of an acrylic/maleic acid homopolymer, an acrylic acid copolymerized with at least one radically polymerizable monomers such as styrene, methyl methacylate, and butyl acrylate, a ring-opened maleic anhydride polymer, a maleic acid polymer ring-opened with a surfactant, a polyethyleneimine, a polyethyleneimine alkoxylate, a cationic polyethyleneimine alkoxylate, or combinations thereof.

Examples of suitable commercially available polymers include: Alcosperse 240, Aquatreat AR 540 and Aquatreat MPS commercially available from Alco Chemical; Acumer 3100, Acumer 2000, Acusol 587G and Acusol 588G commercially available from Rohm & Haas; Goodrich K-798, K-775 and K-797 commercially available from BF Goodrich; ACP 1042 commercially available from ISP technologies Inc; Sokalan PA25, Sokalan CPS, Sokalan HP25, Sokalan HP20, Sokalan HP22, Sokalan HP56, Sokalan HP66, Rheovis CDE, and Rheovis FRC commercially available from BASF.

### Chelant:

Referring back to the chelant, the chelant can be any known in the art. In various non-limiting embodiments, the chelant is as described in WO2011130076, which is expressly incorporated herein by reference. The chelant may be alternatively described as a “builder.”

In various embodiments, the builder is or includes a phosphate builder and/or a phosphate free builder. Builders are typically included in an amount of from 0 to 10, 0.1 to 10, 0.1 to 5, 2.5 to 5, 0.5 to 2, or 0 to 1. In other embodiments, the builder can be included in an amount of 0, 0.1, 0.2, 0.3, 0.4, 0.5, 0.6, 0.7, 0.8, 0.9, 1, or 2 weight percent based on a total weight of the core cleaning composition. All values and ranges of values therebetween are also expressly contemplated herein in various non-limiting embodiments.

Non-limiting examples of suitable phosphate builders include mono-phosphates, di-phosphates, tri-polyphosphates or oligomeric-polyphosphates, and combinations thereof. Alkali metal salts of these compounds can be used, such as sodium salts.

Non-limiting examples of non-phosphate builders include amino acid based compounds, in particular MGDA (methyl-glycine-diacetic acid), and their alkaline earth (Na, K, Li) or combinations of the alkaline earth salts and derivatives thereof, GLDA (glutamic-N,N-diacetic acid) and their alkaline earth (Na, K, Li) or combinations of the alkaline earth salts and derivatives thereof and combinations of MGDA and their alkaline earth salts with GLDA and their alkaline earth (Na, K, Li) or combinations of the alkaline earth salts. In one embodiment, GLDA (salts and derivatives thereof) or tetrasodium salt thereof are used. MGDA typically is or consists of L and D enantiomers and may be, for example, an L-Isomer with an enantiomeric excess (ee) of about 30%. Combinations of L- and D-enantiomers of methyl glycine diacetic acid (MGDA) or its respective mono-, di or trialkali or mono-, di- or triammonium salts, may also be used. In one embodiment, the MGDA is predominantly the respective L-isomer with an enantiomeric excess (ee) from 10 to 75%, or any value or range of values therebetween, including the endpoints.

Other suitable builders include those which form water-soluble hardness ion complexes (e.g. sequestering builder) such as citrates and builders which form hardness precipitates (e.g. precipitating builder) such as carbonates e.g. sodium carbonate. Alternatively, other suitable non-phosphate builders include amino carboxylates, amino acid based compounds, and succinate based compounds. Other suitable builders are described in U.S. Pat. No. 6,426,229, which is expressly incorporated herein by reference in one or more non-limiting embodiments.

In one embodiment, suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), alpha-alanine-N,N-diacetic acid (alpha-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

In other embodiments, suitable non-limiting builders include homopolymers and copolymers of polycarboxylic acids and their partially or completely neutralized salts, monomeric polycarboxylic acids and hydroxycarboxylic acids and their salts. In one embodiment, salts of the abovementioned compounds include the ammonium and/or alkali metal salts, i.e. the lithium, sodium, and potassium salts, and sodium salts may be particularly useful.

Suitable non-limiting polycarboxylic acids include acyclic, alicyclic, heterocyclic and aromatic carboxylic acids. These include at least two carboxyl groups which are typically separated from one another by no more than two carbon atoms. Polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Polycarboxylates which include three carboxyl groups include, for example, water-soluble citrate. Correspondingly, a suitable hydroxycarboxylic acid is, for example, citric acid. Other suitable polycarboxylic acids are the homopolymer of acrylic acid and/or the homopolymer of polyaspartic acid. Other suitable builders are disclosed in U.S. Pat. No. 5,698,504, which is expressly incorporated herein by reference in one or more non-limiting embodiments.

### Enzyme:

Referring back to the enzyme, the enzyme can be any known in the art. In various non-limiting embodiments, the enzyme is as described in WO2011130076, which is expressly incorporated herein by reference in one or more non-limiting embodiments. A combination of two or more enzymes can be used, such as amylases, proteases, cellulases, etc. Such a combination can contribute to an enhanced cleaning across a broader temperature and/or substrate range and provide superior shine benefits, especially when used in conjunction with a polymer. In one embodiment, the enzyme is chosen from amylases, proteases, and combinations thereof.

Suitable non-limiting proteases for use herein include metalloproteases and serine proteases, including neutral or alkaline microbial serine proteases, such as subtilisins (EC 3.4.21.62). Suitable proteases include those of animal, vegetable or microbial origin. Chemically or genetically modified mutants can be included. The protease may be a serine protease, in one embodiment, an alkaline microbial protease or a chymotrypsin or trypsin-like protease.

Non-limiting examples of neutral or alkaline proteases include subtilisins (EC 3.4.21.62), such as those derived from Bacillus (e.g. Bacillus lentus, B. alkalophilus, B. subtilis, B. amyloliquefaciens, Bacillus pumilus and Bacillus gibsonii), as described in, for example, U.S. Pat. Nos. 6,312,936; 5,679,630; 4,760,025; and U.S. Pat. App. Pub. No. 2009/0170745, each of which is expressly incorporated herein by reference in one or more non-limiting embodiments. Other examples of proteases include trypsin-like or chymotrypsin-like proteases, such as trypsin (e.g., of porcine or bovine origin), the Fusarium protease described in U.S. Pat. No. 5,288,627, and the chymotrypsin proteases derived from Cellumonas described in U.S. Pat. App. Pub. No. 2008/0063774, each of which is expressly incorporated herein by reference in one or more non-limiting embodiments. The protease can also be or include a metalloproteases, such as those derived from Bacillus amyloliquefaciens described in U.S. Pat. App. Pub. Nos. 2009/0263882 and 2008/0293610, each of which is expressly incorporated herein by reference in one or more non-limiting embodiments.

Non-limiting examples of suitable commercially available protease enzymes include those sold under the trade names Alcalase®, Savinase®, Primase®, Durazym®, Polarzyme®, Kannase®, Liquanase®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International (now DuPont Inc.), and those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101R+S103A+V1041+G159S, hereinafter referred to as BLAP), BLAP R (BLAP with S3T+V4I+V199M+V2051+L217D), BLAP X (BLAP with S3T+V41+V2051) and BLAP F49 (BLAP with S3T+V4I+A194P+V199M+V2051+L217D)—all from Henkel/Kemira; and KAP (Bacillus alkalophilus subtilisin with mutations A230V+S256G+S259N) from Kao. Each of the aforementioned references are expressly incorporated herein by reference in one or more non-limiting embodiments. In one embodiment, commercial proteases chosen from the group consisting of Properase®, Purafect®, Ovozyme®, Everlase®, Savinase®, Excellase® and FN3® are employed.

Suitable non-limiting amylases for use herein include those described in U.S. Pat. App. Pub. Nos. 2009/0233831 and 2009/0314286, each of which is expressly incorporated herein by reference in one or more non-limiting embodiments. Suitable non-limiting commercially available amylases for use herein include STAINZYME®, STAINZYME PLUS®, STAINZYME ULTRA® and NATALASE® (Novozymes A/S) and Spezyme Xtra® and Powerase®. STAINZYME PLUS® and Powerase® may be particularly useful.

Suitable non-limiting cellulases for use herein include microbial-derived endoglucanases exhibiting endo-beta-1,4-glucanase activity (E.C. 3.2.1.4), including a bacterial polypeptide endogenous to a member of the genus Bacillus which has a sequence of at least 90%, 94%, 97% and even 99% identity to the amino acid sequence SEQ ID NO:2 in U.S. Pat. No. 7,141,403, expressly incorporated herein by reference in one or more non-limiting embodiments, and combinations thereof. Suitable commercially available cellulases for use herein include Carezyme®, Celluzyme®, Celluclean®, Whitezyme® (Novozymes A/S) and Puradax HA® (Genencor International—now Danisco US Inc.).

Other enzymes suitable for use herein can be chosen from hemicellulases, cellobiose dehydrogenases, peroxidases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidase, chondroitinase, laccase, and combinations thereof. In other embodiments, the enzyme may be a lipase, including “first cycle lipases” including a substitution of an electrically neutral or negatively charged amino acid.

The core cleaning composition may also include an enzyme stabilizer such as an oligosaccharide, polysaccharide, borate, boronic acid, glycol, and/or inorganic divalent metal salts, such as alkaline earth metal salts, especially calcium salts. Chlorides and sulphates may be particularly suitable. Non-limiting examples of suitable oligosaccharides and polysaccharides, such as dextrins, are described in U.S. Pat. App. Pub. No. 2008/000420, which is expressly incorporated herein by reference in one or more non-limiting embodiments.

The enzyme may be included in an amount of from 0 to 10, 0.1 to 10, 0.1 to 5, 2.5 to 5, 0.5 to 2, or 0 to 1. In some embodiments the enzyme is included in an amount of 0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 weight percent based on a total weight of the core cleaning composition. All values and ranges of values therebetween are also expressly contemplated herein in various non-limiting embodiments.

### Silicates:

The core cleaning composition may also include silicate. Suitable silicates are sodium silicates such as sodium disilicate, sodium metasilicate and crystalline phyllosilicates. Silicates can be present in an amount of from 1% to 20%, or from 5% to 15% by weight of the core cleaning composition. All values and ranges of values therebetween are also expressly contemplated herein in various non-limiting embodiments.

### Bleach:

The core cleaning composition may also include a bleach. Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Alkali metal percarbonates, particularly sodium percarbonate can also be utilized. The percarbonate is most typically incorporated into the products in a coated form which provides in-product stability. A suitable coating material providing in product stability includes mixed salt of a water-soluble alkali metal sulfate and carbonate. The weight ratio of the mixed salt coating material to percarbonate is typically from 1:200 to 1:4, from 1:99 to 19, or from 1:49 to 1:19. In one embodiment, the mixed salt is of sodium sulfate and sodium carbonate which has the general formula (Na₂SO₄)ₙNa₂CO₃ wherein n is from 0.1 to 3, from 0.2 to 1.0 or from 0.2 to 0.5. Sodium silicate of SiO₂:Na₂O ratio from 1.8:1 to 3.0:1, or L8:1 to 2.4:1, and/or sodium metasilicate, in one embodiment, are applied at a level of from 2% to 10%, (normally from 3% to 5%) of SiO₂ by weight of the inorganic perhydrate salt. All values and ranges of values therebetween are also expressly contemplated herein in various non-limiting embodiments. Magnesium silicate can also be included in the coating. Compounds that include silicate and borate salts or boric acids or other inorganics are also suitable.

Other examples of organic bleaches include waxes, oils, fatty soaps, and salts such as potassium peroxymonopersulfate. Typical organic bleaches are organic peroxyacids including diacyl and tetraacylperoxides, especially diperoxydodecanedioc acid, diperoxytetradecanedioc acid, and diperoxyhexadecanedioc acid. Dibenzoyl peroxide is a typical organic peroxyacid herein. Mono- and diperazelaic acid, mono- and diperbrassylic acid, and phthaloylaminoperoxicaproic acid are also suitable herein. The diacyl peroxide, especially dibenzoyl peroxide, can be present in the form of particles having a weight average diameter of from 0.1 to 100 microns, from 0.5 to 30 microns, or from 1 to 10 microns. In one embodiment, at least 25%, at least 50%, at least 75%, or at least 90%, of the particles are smaller than 10 microns, or smaller than 6 microns. Diacyl peroxides within the above particle size range can provide better stain removal, while minimizing undesirable deposition and filming during use, than larger diacyl peroxide particles.

Further examples of suitable organic bleaches include the peroxy acids, particular examples being the alkylperoxy acids and the arylperoxy acids. Typical examples include (a) peroxybenzoic acid and its ring-substituted derivatives, such as alkylperoxybenzoic acids, and also peroxy-.alpha.-naphthoic acid and magnesium monoperphthalate, (b) aliphatic or substituted aliphatic peroxy acids, such as peroxylauric acid, peroxystearic acid, epsilon-phthalimidoperoxycaproic acid [phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators:

The core cleaning composition may also include a bleach activator. Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having from 1 to 10 carbon atoms, in particular from 2 to 4 carbon atoms, and/or optionally substituted perbenzoic acid. Suitable compounds include O-acyl and/or N-acyl groups of the number of carbon atoms specified and/or optionally substituted benzoyl groups. In various embodiments, preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators can be utilized in an amount of from 0.1% to 10%, or from 0.5% to 2% by weight of the total core cleaning composition. All values and ranges of values therebetween are also expressly contemplated herein in various non-limiting embodiments.

### Bleach Catalyst:

The core cleaning composition may also include a bleach catalyst. Suitable bleach catalysts include the manganese triazacyclononane), Co, Cu, Mn and Fe bispyridylamine and related complexes, and pentamine acetate cobalt(III) and related complexes. In various embodiments, the bleach catalyst is utilized in an amount from 0.1 to 10, or from 0.5 to 2, percent by weight based on a total weight of the core cleaning composition. All values and ranges of values therebetween are also expressly contemplated herein in various non-limiting embodiments.

### Metal Care Agents:

The core cleaning composition may also include a metal care agent. Metal care agents may prevent or reduce the tarnishing, corrosion or oxidation of metals, including aluminum, stainless steel and non-ferrous metals, such as silver and copper. Suitable examples include one or more of the following: (a) benzatriazoles, including benzotriazole or bis-benzotriazole and substituted derivatives thereof such as compounds in which the available substitution sites on the aromatic ring are partially or completely substitute, e.g. linear or branch-chain C₁ to C₂₀ alkyl groups and hydroxyl, thio, phenyl or halogen such as fluorine, chlorine, bromine and iodine; (b) metal salts and complexes chosen from zinc, manganese, titanium, zirconium, hafnium, vanadium, cobalt, gallium and cerium salts and/or complexes, e.g. Mn(II) sulfate, Mn(II) citrate, Mn(II) stearate, Mn(II) acetylacetonate, K₂TiF₆, K₂ZrF₆, CoSO₄, Co(NO₃)₂ and Ce(NO₃)₃, zinc salts, for example zinc sulfate, hydrozincite or zinc acetate; and (c) silicates, including sodium or potassium silicate, sodium disilicate, sodium metasilicate, crystalline phyllosilicate and combinations thereof. In various embodiments, the metal care agent is utilized in an amount from 0.1 to 5, from 0.2 to 4, or from 0.3 to 3, percent by weight based on a total weight of the core cleaning composition. All values and ranges of values therebetween are also expressly contemplated herein in various non-limiting embodiments.

### Additional Embodiments

In additional embodiments, the core cleaning composition includes water, an ionic liquid (e.g. Tris(2-hydroxyethyl)methylammonium methylsulfate, one or more additional solvents (e.g. propylene glycol, glycerine, and/or ethanol), one or more chelants (e.g. citrate), one or more polymers (e.g. Sokalan PA25, Sokalan CPS, Sokalan HP25, Sokalan HP20, Sokalan HP22, Sokalan HP56, Sokalan HP66, Rheovis CDE, and Rheovis FRC, which are commercially available from BASF), and one, two, or more enzymes (e.g., a liquid protease commercially available from Novozymes under the tradename Savinase Ultra 16 L and a liquid amylase commercially available from Novozymes under the tradename Stainzyme Plus 12L). In a similar additional embodiment, the water is present in an amount of 25 parts by weight per 100 parts per weight of the core cleaning composition, the surfactant is present in an amount of 44 parts by weight per 100 parts per weight of the core cleaning composition, the ionic liquid is present in an amount of 27 parts by weight per 100 parts per weight of the core cleaning composition, the additional solvent is present in an amount of 30 parts by weight per 100 parts per weight of the core cleaning composition, and the enzyme is present in an amount of 0.5 parts by weight per 100 parts per weight of the core cleaning composition. In other similar additional embodiments, one or more of the aforementioned values may vary ±0.1, 0.5. 1, 2, 3, 4, 5, 6, 7, 8, 9, or 10, %.

### Water-Soluble Film:

The encapsulated cleaning composition also includes the water-soluble film disposed about the core cleaning composition. The terminology “water-soluble” film describes a film having a disintegration time of less than 90, 85, 80, 75, 70, 65, 60, 55, 50, 45, 40, 35, or 30, seconds as determined at 40° C. using distilled water according to MSTM 205 when disposed about the core cleaning composition or when measured independently from the core cleaning composition. In other embodiments, this disintegration time is evaluated at 35° C., 30° C., 25° C., 20° C., 15° C., 10° C., or 5° C., and may be any of the above values or ranges thereof. In various additional embodiments, the water-soluble film described above has a complete solubility time of less than 135, 130, 125, 120, 115, 110, 105, 100, 95, 90, 85, 80, 75, 70, 65, 60, 55, 50, 45, 40, 35, or 30, seconds as determined at 40° C., 35° C., 30° C., 25° C., 20° C., 15° C., 10° C., or 5° C., using distilled water according to MSTM 205 when disposed about the core cleaning composition or when measured independently from the core cleaning composition. In still further embodiments, the film has a disintegration time of less than 300, 275, 250, 225, 200, 175, 150, 125, 100, 75, 50, or 25, seconds as determined at 10° C. using distilled water according to MSTM 205 when disposed about the core cleaning composition or when measured independently from the core cleaning composition.

In various embodiments, the water-soluble film may have one or more of the following physical properties or physical properties not set forth below. All values and ranges of values between and including all of the following ranges are hereby expressly contemplated in various non-limiting embodiments. All of the following values are in seconds and can be applied to embodiments that include zero exposure to the conditions described below, exposure for 14 days, exposure for 28 days, and/or exposure for 42 days. The standard deviation for the following values is typically 0, 1, 2, 3, 4, 5, 6, 7, 8, 9, or 10, seconds.

| “Complete Solubility” Time | | | “Disintegration” Time | | |
|---|---|---|---|---|---|
| in Distilled Water at 25° C. When | | | in Distilled Water at 25° C. When | | |
| Pre-Exposed to Various Conditions | | | Pre-Exposed to Various Conditions | | |
| as Determined using MSTM 205 | | | as Determined using MSTM 205 | | |
| Ambient | 38° C./ | 38° C./ | Ambient | 38° C./ | 38° C./ |
| Temp/Humid | 80% RH | 10% RH | Temp/Humid | 80% RH | 10% RH |
| 32-42 sec. | 32-67 sec. | 32-57 sec. | 14-16 sec. | 14-28 sec. | 14-25 sec. |
| 49-52 sec. | 50-63 sec. | 50-62 sec. | 21-23 sec. | 23-27 sec. | 23-26 sec. |
| 29-31 sec. | 29-37 sec. | 29-34 sec. | 13-15 sec. | 15-17 sec. | 15-16 sec. |
| 32-60 sec. | 32-138 sec. | 32-111 sec. | 14-19 sec. | 14-33 sec. | 14-30 sec. |
| 49-56 sec. | 50-62 sec. | 50-59 sec. | 22-23 sec. | 22-24 sec. | 23-25 sec. |
| 29-33 sec. | 29-33 sec. | 29-34 sec. | 14-15 sec. | 14-15 sec. | 14-15 sec. |
| 32-42 sec. | 32-68 sec. | 32-64 sec. | 14-17 sec. | 14-24 sec. | 14-25 sec. |
| 46-53 sec. | 50-53 sec. | 50-59 sec. | 22-23 sec. | 23-25 sec. | 23-26 sec. |
| 29-35 sec. | 29-36 sec. | 29-37 sec. | 14-15 sec. | 15-17 sec. | 15-16 sec. |
| 32-41 sec. | 32-62 sec. | 32-58 sec. | 14-15 sec. | 14-24 sec. | 14-21 sec. |
| 45-50 sec. | 50-55 sec. | 50-51 sec. | 20-23 sec. | 21-24 sec. | 22-23 sec. |
| 29-31 sec. | 29-33 sec. | 29-31 sec. | 13-15 sec. | 13-15 sec. | 14-15 sec. |

Ambient Temperature and Humidity is about 22° C. and about 40% RH.

The following test procedure, referred to herein as MSTM 205, is used to determine the time required for a water-soluble film to break apart (disintegrate) and its subsequent relative dissolution time when held stationary. Additionally, reference can be made to U.S. Pat. No. 6,821,590, and the figures thereof, which is expressly incorporated herein by reference relative to this test method, in various non-limiting embodiments.

### Apparatus and Materials:

A 600 mL Beaker

A magnetic stirrer 14 (Labline Model No. 1250 or equivalent)

A magnetic stirring rod 16 (5 cm)

A thermometer (0 to 100° C., ±1° C.)

A template, stainless steel (3.8 cm×3.2 cm)

A timer, (0-300 seconds, accurate to the nearest second)

A Polaroid 35 mm slide mount (or equivalent)

A MonoSol 35 mm slide mount holder (or equivalent)

Distilled water

Test Specimen:
1. Cut three test specimens from a sample using the stainless steel template (i.e., 3.8 cm×3.2 cm specimen). If cut from a film web, specimens should be cut from areas evenly spaced along the transverse direction of the web.
2. Lock each specimen in a separate 35 mm slide mount.
3. Fill the beaker with 500 mL of distilled water. Measure the water temperature with the thermometer and, if necessary, heat or cool the water to maintain temperature at 20° C. (about 68° F.).
4. Mark the height of the column of water. Place a magnetic stirrer on the base of the holder. Place the beaker on magnetic stirrer, add the magnetic stirring rod to beaker, turn on the stirrer, and adjust the stir speed until a vortex develops which is approximately one-fifth the height of the water column. Mark the depth of vortex.
5. Secure the 35 mm slide mount in an alligator clamp of the slide mount holder such that a long end of the slide mount is parallel to the water surface. A depth adjuster of the holder should be set so that when dropped, the end of the clamp will be about 0.6 cm below the surface of the water. One of the short sides of the slide mount should be disposed next to the side of the beaker with the other positioned directly over the center of the stirring rod such that the film surface is perpendicular to the flow of the water.
6. In one motion, drop the secured slide and clamp into the water and start the timer. Disintegration occurs when the film breaks apart. When all visible film is released from the slide mount, raise the slide out of the water while continuing to monitor the solution for undissolved film fragments. Dissolution occurs when all film fragments are no longer visible and the solution becomes clear.

Data Recording:

The results can include the following:
complete sample identification;
individual and average disintegration and dissolution times; and
water temperature at which the samples were tested.

Standard quality control procedures may be followed with respect to bubble and pin-hole inspection. However, such quality checks may not be necessary.

It is contemplated that the water-soluble film may have different disintegration properties and/or complete solubility properties if measured independently when not disposed about the core cleaning composition. The water-soluble film may or may have the aforementioned disintegration time when not disposed about the core cleaning composition and when evaluated independently from the core cleaning composition.

The water-soluble film may remain stable for or at 6 months at 25° C. when disposed about the core cleaning composition under varying temperatures and humidity conditions, e.g. after exposure to varying temperatures of from 22° C. to 38° C. and 10% to 80% relative humidity over a varying number of days, e.g. up to 6 months. In other words, the water-soluble film may remain intact after such a time period. In various embodiments, the water-soluble film is stable after exposure to 38° C. and 80% relative humidity for 14, 28, and/or 42 days. In other embodiments, the water-soluble film is stable after exposure to 38° C. and 10% relative humidity for 14, 28, and/or 42 days. In still other embodiments, the water-soluble film is stable after exposure to ambient temperature and (relative) humidity, as understood by those of skill in the art, for 14, 28, and/or 42 days. In various embodiments, ambient temperature is 22° C., 23° C., 24° C., or 25, ° C. and ambient (relative) humidity is 30%, 35%, 40%, 45%, or 50%. All values and ranges of values between and including the aforementioned values are hereby expressly contemplated in various non-limiting embodiments.

The terminology “stable” describes that the water-soluble film does not dissolve via contact with the water or any other components in the core cleaning composition. Stability can be equated to non-leakage of the core cleaning composition (e.g. the film remains intact for the specified amount of time). The stability/dissolution of the film can be evaluated visually, typically in accordance with MSTM 205, as described above. This visual evaluation can also be made by examining the film for leakage using a tissue paper to blot the film and look for wet spots, as well as manipulating the film to look for significant deformation, swelling, or brittleness, (e.g. that could cause immediately failure upon exposure to water, such as in a laundry washer), as would be understood by one of skill in the art. Typically, dissolution is affirmed if/when there is leakage of the core cleaning composition through or out of the film. For example, dissolution can be affirmed when there is partial leakage and not necessarily only upon total lyses of the film. Alternatively, dissolution may be affirmed when there is total dissolution of the film and/or lyses of the film and/or extensive leakage of the encapsulated cleaning composition. Still further, dissolution may be affirmed if there is enough significant deformation, swelling, or brittleness of the encapsulated cleaning composition such that the water-soluble film would be considered to be structurally compromised, could not be used, and/or could not function commercially, as would be understood by those of skill in the art. If no dissolution is affirmed/present prior to placement of the encapsulated cleaning composition in water, then a person of skill in the art can affirm that the encapsulated cleaning composition is stable. It is contemplated that the water-soluble film may have different stability/dissolution properties if measured independently when not disposed about the core cleaning composition.

In other embodiments, the water-soluble film may have an elongation as set forth below or may have a different elongation. All values and ranges of values between and including all of the following ranges are hereby expressly contemplated in various non-limiting embodiments. Typically, elongation is measured using ISO 527-4, or its equivalent, as appreciated by those of skill in the art. The standard deviation for the following values is typically 0, 1, 2, or 3, units. The values below are elongation at break (%).

Elongation When Pre-Exposed to Various Conditions

| Ambient | 23° C./ | 38° C./ | 38° C./ |
|---|---|---|---|
| Temp/Humid | 50% RH | 80% RH | 10% RH |
| 572/25 | 814/15 | 739/103 | 745/23 |
| 537/40 | 759/20 | 699/49 | 736/15 |
| 447/13 | 761/26 | 703/32 | 648/15 |
| 572/25 | 704/13 | 706/37 | 733/37 |
| 537/40 | 656/12 | 670/20 | 680/10 |
| 447/13 | 620/8 | 623/20 | 636/8 |
| 572/25 | 536/10 | 462/29 | 456/9 |
| 537/40 | 519/7 | 441/7 | 419/34 |
| 447/13 | 409/30 | 195/58 | 305/51 |
| 572/25 | 550/63 | 520/41 | 581/14 |
| 537/40 | 492/67 | 497/32 | 486/23 |
| 447/13 | 455/16 | 441/46 | 449/55 |

The water-soluble film may be, include, consist essentially of, or consist of, any water-soluble compound or polymer that meets the aforementioned criteria of disintegration and stability times. For example, such compounds or polymers could be polyvinyl alcohol (PVA or PVOH), polyvinyl acetate, polyvinyl acetate having 88-98% of all acetate groups hydrolyzed, gelatin, and combinations thereof. Alternatively, the water-soluble film may be as described in U.S. Pat. Nos. 4,765,916 or 4,972,017, each of which is expressly incorporated herein by reference in one or more non-limiting embodiments. In various embodiments, the water-soluble film is thermoplastic.

The water-soluble film may be further defined as a water-soluble pouch and may be formed from, comprise, consist of, be, or consist essentially of any one or more of the aforementioned compounds. The water-soluble pouch may be a single chamber, a dual chamber, or a multi-chamber pouch wherein the core cleaning composition may be disposed in one or more of the chambers. Alternatively, any one or more of the aforementioned components may be disposed in one or more of the chambers. For example, in one embodiment, two different chambers include two different cleaning agents. The two chambers could have the same or different dissolution profiles allowing the release of the same or different agents at different times. For example, the agent from a first chamber could be delivered at a first time to help with soil removal and a second agent could be delivered at a second time for a different reason.

The water-soluble pouch and/or film may be, include, consist of, or consist essentially of polyvinyl alcohol, such as the type commercially available from Monosol under the trade names of M8630, M8310, and/or M8900. For example, the compositions can be independently encapsulated in Monosol (water-soluble) PVA pouches M8630, M8310, and/or M8900 which are various types of water-soluble films, to evaluate whether the pouches are stable over time. In other words, the pouches can be disposed about the core cleaning compositions. In other embodiments, the following Monosol products may be utilized alone or in combination with each other or with any of the aforementioned polymers: A127, A200, L330, L336, L336 Blue, L711, L711 Blue, M1030, M1030, M2000, M2631A, M3030, M6030, M7030, M7031, M7061, M8310, M8440, M8534, M8630, M8900, and/or M9500.

The water-soluble film and/or pouch may be a single layer, two layers, three layers, four layers, five layers, or more than five layers of any one or more of the aforementioned polymers. In various embodiments, each layer or the total combination of layers may have a thickness of from 5 to 200, 5 to 100, 10 to 95, 15 to 90, 20 to 85, 25 to 80, 30 to 75, 35 to 70, 40 to 65, 45 to 60, 50 to 55, microns. In still other embodiments, each layer or the total combination of layers has a thickness of 20, 22, 30, 32, 35, 38, 50, 76, or 90, microns, ±1, 2, 3, 4, or 5, microns. All values and ranges of values between and including the aforementioned values are hereby expressly contemplated in various non-limiting embodiments.

This disclosure also provides a method of forming the encapsulated cleaning composition. In various embodiments, the method includes the steps of providing the core cleaning composition and disposing the water-soluble film about the core cleaning composition. The step of providing may be any known in the art. Any one or more of the components of the composition may be combined with any one or more other components of the core cleaning composition. Moreover, the step of disposing may also be any known in the art. For example, the step of disposing may include pouring, inserting, injecting, or otherwise placing the core cleaning composition, or any one more components thereof, into water-soluble film, e.g. into a pouch of the water-soluble film.

The encapsulated cleaning composition is intended for use in a washing machine, such as a laundry washer. The encapsulated cleaning composition may also be used in an auto-dosing device, wherein the auto-dosing device is placed into a washing machine, e.g. a laundry washer, and holds a plurality of the encapsulated core compositions to be delivered in different washes.

### Examples

A series of Core Cleaning Compositions (Compositions 1-27) are formed as set forth below. Some are representative of this disclosure and some are comparative.

Each of the Compositions 1-27 is formulated by:
1. adding together water, primary surfactant(s), primary surfactant modifier(s), secondary surfactant(s), additive(s), ionic liquid(s), and additional solvent(s) to produce a base composition;
2. heating the base composition to above room temperature (e.g. 35-40° C.); and
3. adding to the heated base composition various amounts of primary surfactant and additional solvent(s) to produce the formulated Compositions 1-27, which are described in further detail below.

Notably, in the Examples (as first introduced above), the detergent may be any component or mixture of components that can exhibit detersive properties. The detergent may include or be a single component, or may include or be any number of individual components. In some embodiments, the detergent includes or is only one component (e.g. a surfactant, as described in further detail below). In other embodiments, the detergent includes or is more than 1 component (e.g. a mixture of two or more surfactants). For example, the surfactant system may include the detergent (e.g. 1 or more surfactants), the solvents as the ionic liquid and water, and optionally a third solvent, and other ingredients are also possible (e.g. polymer, enzyme, etc.).

The formulation of each of Compositions 1-27 is shown below:

| | Composition 1 | | Composition 2 | | Composition 3 | |
|---|---|---|---|---|---|---|
| Added Ingredient | % Active | Wt. % | % Active | Wt. % | % Active | Wt. % |
| Primary Surfactant 1 | 97.00 | 22.29 | 97.00 | 22.29 | 97.00 | 22.29 |
| Primary Surfactant 1 | 100.00 | 5.75 | 100.00 | 5.75 | 100.00 | 5.75 |
| Modifier | | | | | | |
| Primary Surfactant 2 | 100.00 | 21.63 | 100.00 | 21.63 | 100.00 | 21.63 |
| Primary Surfactant 3 | 70.00 | 7.14 | 70.00 | 7.14 | 70.00 | 7.14 |
| Secondary Surfactant 1 | 100.00 | 5.50 | 100.00 | 5.50 | 100.00 | 5.50 |
| Secondary Surfactant 2 | 100.00 | 4.25 | 100.00 | 4.25 | 100.00 | 4.25 |
| Additive 1 | 90.00 | 0.11 | 90.00 | 0.11 | 90.00 | 0.11 |
| Additive 2 | 60.00 | 0.50 | 60.00 | 0.50 | 60.00 | 0.50 |
| Additive 3 | 30.00 | 0 | 30.00 | 0 | 30.00 | 0 |
| Ionic Liquid | — | 20.16 | — | 19.75 | — | 19.28 |
| Additional Solvent 1 | — | 5.00 | — | 5.41 | — | 5.88 |
| (non-aq.) | | | | | | |
| Additional Solvent 2 | — | 0.00 | — | 0.00 | — | 0.00 |
| (non-aq.) | | | | | | |
| Water | — | 7.66 | — | 7.66 | — | 7.66 |
| SUM | | 100.00 | | 100.00 | | 100.00 |
| | Composition 4 | | Composition 5 | | Composition 6 | |
| Added Ingredient | % Active | Wt. % | % Active | Wt. % | % Active | Wt. % |
| Primary Surfactant 1 | 97.00 | 22.29 | 97.00 | 22.29 | 97.00 | 22.29 |
| Primary Surfactant 1 | 100.00 | 5.75 | 100.00 | 5.75 | 100.00 | 5.75 |
| Modifier | | | | | | |
| Primary Surfactant 2 | 100.00 | 21.63 | 100.00 | 21.63 | 100.00 | 21.63 |
| Primary Surfactant 3 | 70.00 | 7.14 | 70.00 | 7.14 | 70.00 | 7.14 |
| Secondary Surfactant 1 | 100.00 | 5.50 | 100.00 | 5.50 | 100.00 | 5.50 |
| Secondary Surfactant 2 | 100.00 | 4.25 | 100.00 | 4.25 | 100.00 | 4.25 |
| Additive 1 | 90.00 | 0.11 | 90.00 | 0.11 | 90.00 | 0.11 |
| Additive 2 | 60.00 | 0.50 | 60.00 | 0.50 | 60.00 | 0.50 |
| Additive 3 | 30.00 | 0 | 30.00 | 0 | 30.00 | 0 |
| Ionic Liquid | — | 15.16 | — | 14.75 | — | 14.28 |
| Additional Solvent 1 | — | 5.00 | — | 5.41 | — | 5.88 |
| (non-aq.) | | | | | | |
| Additional Solvent 2 | — | 5.00 | — | 5.00 | — | 5.00 |
| (non-aq.) | | | | | | |
| Water | — | 7.66 | — | 7.66 | — | 7.66 |
| SUM | | 100.00 | | 100.00 | | 100.00 |
| | Composition 7 | | Composition 8 | | Composition 9 | |
| Added Ingredient | % Active | Wt. % | % Active | Wt. % | % Active | Wt. % |
| Primary Surfactant 1 | 97.00 | 22.29 | 97.00 | 22.29 | 97.00 | 22.29 |
| Primary Surfactant 1 | 100.00 | 5.75 | 100.00 | 5.75 | 100.00 | 5.75 |
| Modifier | | | | | | |
| Primary Surfactant 2 | 100.00 | 21.63 | 100.00 | 21.63 | 100.00 | 21.63 |
| Primary Surfactant 3 | 70.00 | 7.14 | 70.00 | 7.14 | 70.00 | 7.14 |
| Secondary Surfactant 1 | 100.00 | 5.50 | 100.00 | 5.50 | 100.00 | 5.50 |
| Secondary Surfactant 2 | 100.00 | 4.25 | 100.00 | 4.25 | 100.00 | 4.25 |
| Additive 1 | 90.00 | 0.11 | 90.00 | 0.11 | 90.00 | 0.11 |
| Additive 2 | 60.00 | 0.50 | 60.00 | 0.50 | 60.00 | 0.50 |
| Additive 3 | 30.00 | 0 | 30.00 | 0 | 30.00 | 0 |
| Ionic Liquid | — | 12.66 | — | 12.05 | — | 11.34 |
| Additional Solvent 1 | — | 7.50 | — | 8.11 | — | 8.83 |
| (non-aq.) | | | | | | |
| Additional Solvent 2 | — | 0.00 | — | 0.00 | — | 0.00 |
| (non-aq.) | | | | | | |
| Water | — | 12.66 | — | 12.66 | — | 12.66 |
| SUM | | 100.00 | | 100.00 | | 100.00 |
| | Composition 10 | | Composition 11 | | Composition 12 | |
| Added Ingredient | % Active | Wt. % | % Active | Wt. % | % Active | Wt. % |
| Primary Surfactant 1 | 97.00 | 22.29 | 97.00 | 22.29 | 97.00 | 22.29 |
| Primary Surfactant 1 | 100.00 | 5.75 | 100.00 | 5.75 | 100.00 | 5.75 |
| Modifier | | | | | | |
| Primary Surfactant 2 | 100.00 | 21.63 | 100.00 | 21.63 | 100.00 | 21.63 |
| Primary Surfactant 3 | 70.00 | 7.14 | 70.00 | 7.14 | 70.00 | 7.14 |
| Secondary Surfactant 1 | 100.00 | 5.50 | 100.00 | 5.50 | 100.00 | 5.50 |
| Secondary Surfactant 2 | 100.00 | 4.25 | 100.00 | 4.25 | 100.00 | 4.25 |
| Additive 1 | 90.00 | 0.11 | 90.00 | 0.11 | 90.00 | 0.11 |
| Additive 2 | 60.00 | 0.50 | 60.00 | 0.50 | 60.00 | 0.50 |
| Additive 3 | 30.00 | 0 | 30.00 | 0 | 30.00 | 0 |
| Ionic Liquid | — | 10.16 | — | 9.55 | — | 8.84 |
| Additional Solvent 1 | — | 7.50 | — | 8.11 | — | 8.83 |
| (non-aq.) | | | | | | |
| Additional Solvent 2 | — | 2.50 | — | 2.50 | — | 2.50 |
| (non-aq.) | | | | | | |
| Water | — | 12.66 | — | 12.66 | — | 12.66 |
| SUM | | 100.00 | | 100.00 | | 100.00 |
| | Composition 13 | | Composition 14 | | Composition 15 | |
| Added Ingredient | % Active | Wt. % | % Active | Wt. % | % Active | Wt. % |
| Primary Surfactant 1 | 97.00 | 18.45 | 97.00 | 18.45 | 97.00 | 18.45 |
| Primary Surfactant 1 | 100.00 | 4.76 | 100.00 | 4.76 | 100.00 | 4.76 |
| Modifier | | | | | | |
| Primary Surfactant 2 | 100.00 | 17.90 | 100.00 | 17.90 | 100.00 | 17.90 |
| Primary Surfactant 3 | 70.00 | 5.91 | 70.00 | 5.91 | 70.00 | 5.91 |
| Secondary Surfactant 1 | 100.00 | 4.55 | 100.00 | 4.55 | 100.00 | 4.55 |
| Secondary Surfactant 2 | 100.00 | 3.52 | 100.00 | 3.52 | 100.00 | 3.52 |
| Additive 1 | 90.00 | 0.11 | 90.00 | 0.11 | 90.00 | 0.11 |
| Additive 2 | 60.00 | 0.50 | 60.00 | 0.50 | 60.00 | 0.50 |
| Additive 3 | 30.00 | 0 | 30.00 | 0 | 30.00 | 0 |
| Ionic Liquid | — | 19.00 | — | 17.38 | — | 14.84 |
| Additional Solvent 1 | — | 7.27 | — | 8.89 | — | 11.43 |
| (non-aq.) | | | | | | |
| Additional Solvent 2 | — | 0.00 | — | 0.00 | — | 0.00 |
| (non-aq.) | | | | | | |
| Water | — | 18.03 | — | 18.03 | — | 18.03 |
| SUM | | 100.00 | | 100.00 | | 100.00 |
| | Composition 16 | | Composition 17 | | Composition 18 | |
| Added Ingredient | % Active | Wt. % | % Active | Wt. % | % Active | Wt. % |
| Primary Surfactant 1 | 97.00 | 18.45 | 97.00 | 18.45 | 97.00 | 18.45 |
| Primary Surfactant 1 | 100.00 | 4.76 | 100.00 | 4.76 | 100.00 | 4.76 |
| Modifier | | | | | | |
| Primary Surfactant 2 | 100.00 | 17.90 | 100.00 | 17.90 | 100.00 | 17.90 |
| Primary Surfactant 3 | 70.00 | 5.91 | 70.00 | 5.91 | 70.00 | 5.91 |
| Secondary Surfactant 1 | 100.00 | 4.55 | 100.00 | 4.55 | 100.00 | 4.55 |
| Secondary Surfactant 2 | 100.00 | 3.52 | 100.00 | 3.52 | 100.00 | 3.52 |
| Additive 1 | 90.00 | 0.11 | 90.00 | 0.11 | 90.00 | 0.11 |
| Additive 2 | 60.00 | 0.50 | 60.00 | 0.50 | 60.00 | 0.50 |
| Additive 3 | 30.00 | 0 | 30.00 | 0 | 30.00 | 0 |
| Ionic Liquid | — | 22.27 | — | 24.27 | — | 25.27 |
| Additional Solvent 1 | — | 4.00 | — | 2.00 | — | 1.00 |
| (non-aq.) | | | | | | |
| Additional Solvent 2 | — | 0.00 | — | 0.00 | — | 0.00 |
| (non-aq.) | | | | | | |
| Water | — | 18.03 | — | 18.03 | — | 18.03 |
| SUM | | 100.00 | | 100.00 | | 100.00 |
| | Composition 19 | | Composition 20 | | Composition 21 | |
| Added Ingredient | % Active | Wt. % | % Active | Wt. % | % Active | Wt. % |
| Primary Surfactant 1 | 97.00 | 15.38 | 97.00 | 15.38 | 97.00 | 15.38 |
| Primary Surfactant 1 | 100.00 | 3.97 | 100.00 | 3.97 | 100.00 | 3.97 |
| Modifier | | | | | | |
| Primary Surfactant 2 | 100.00 | 14.91 | 100.00 | 14.91 | 100.00 | 14.91 |
| Primary Surfactant 3 | 70.00 | 4.93 | 70.00 | 4.93 | 70.00 | 4.93 |
| Secondary Surfactant 1 | 100.00 | 3.79 | 100.00 | 3.79 | 100.00 | 3.79 |
| Secondary Surfactant 2 | 100.00 | 2.93 | 100.00 | 2.93 | 100.00 | 2.93 |
| Additive 1 | 90.00 | 0.11 | 90.00 | 0.11 | 90.00 | 0.11 |
| Additive 2 | 60.00 | 0.50 | 60.00 | 0.50 | 60.00 | 0.50 |
| Additive 3 | 30.00 | 0 | 30.00 | 0 | 30.00 | 0 |
| Ionic Liquid | — | 21.07 | — | 19.05 | — | 15.88 |
| Additional Solvent 1 | — | 9.09 | — | 11.11 | — | 14.28 |
| (non-aq.) | | | | | | |
| Additional Solvent 2 | — | 0.00 | — | 0.00 | — | 0.00 |
| (non-aq.) | | | | | | |
| Water | — | 23.32 | — | 23.32 | — | 23.32 |
| SUM | | 100.00 | | 100.00 | | 100.00 |
| | Composition 22 | | Composition 23 | | Composition 24 | |
| Added Ingredient | % Active | Wt. % | % Active | Wt. % | % Active | Wt. % |
| Primary Surfactant 1 | 97.00 | 15.38 | 97.00 | 15.38 | 97.00 | 15.38 |
| Primary Surfactant 1 | 100.00 | 3.97 | 100.00 | 3.97 | 100.00 | 3.97 |
| Modifier | | | | | | |
| Primary Surfactant 2 | 100.00 | 14.91 | 100.00 | 14.91 | 100.00 | 14.91 |
| Primary Surfactant 3 | 70.00 | 4.93 | 70.00 | 4.93 | 70.00 | 4.93 |
| Secondary Surfactant 1 | 100.00 | 3.79 | 100.00 | 3.79 | 100.00 | 3.79 |
| Secondary Surfactant 2 | 100.00 | 2.93 | 100.00 | 2.93 | 100.00 | 2.93 |
| Additive 1 | 90.00 | 0.11 | 90.00 | 0.11 | 90.00 | 0.11 |
| Additive 2 | 60.00 | 0.50 | 60.00 | 0.50 | 60.00 | 0.50 |
| Additive 3 | 30.00 | 0 | 30.00 | 0 | 30.00 | 0 |
| Ionic Liquid | — | 25.16 | — | 27.66 | — | 28.91 |
| Additional Solvent 1 | — | 5.00 | — | 2.50 | — | 1.25 |
| (non-aq.) | | | | | | |
| Additional Solvent 2 | — | 0.00 | — | 0.00 | — | 0.00 |
| (non-aq.) | | | | | | |
| Water | — | 23.32 | — | 23.32 | — | 23.32 |
| SUM | | 100.00 | | 100.00 | | 100.00 |
| | Composition 25 | | Composition 26 | | Composition 27 | |
| Added Ingredient | % Active | Wt. % | % Active | Wt. % | % Active | Wt. % |
| Primary Surfactant 1 | 97.00 | 22.59 | 97.00 | 22.59 | 97.00 | 22.59 |
| Primary Surfactant 1 | | | | | | |
| Modifier | 100.00 | 5.61 | 100.00 | 5.61 | 100.00 | 5.61 |
| Primary Surfactant 2 | 100.00 | 21.91 | 100.00 | 21.91 | 100.00 | 21.91 |
| Primary Surfactant 3 | 70.00 | 7.14 | 70.00 | 7.14 | 70.00 | 7.14 |
| Secondary Surfactant 1 | 100.00 | 5.18 | 100.00 | 5.18 | 100.00 | 5.18 |
| Secondary Surfactant 2 | 100.00 | 4.00 | 100.00 | 4.00 | 100.00 | 4.00 |
| Additive 1 | 90.00 | 0.11 | 90.00 | 0.11 | 90.00 | 0.11 |
| Additive 2 | 30.00 | 3.33 | 30.00 | 3.33 | 30.00 | 3.33 |
| Additive 3 | 30.00 | 3.33 | 30.00 | 3.33 | 30.00 | 3.33 |
| Ionic Liquid | — | 0.00 | — | 0.00 | — | 0.00 |
| Additional Solvent 1 | — | 24.35 | — | 19.35 | — | 14.35 |
| (non-aq.) | | | | | | |
| Additional Solvent 2 | — | 0.00 | — | 0.00 | — | 0.00 |
| (non-aq.) | | | | | | |
| Water | — | 5.28 | — | 10.28 | — | 15.28 |
| SUM | | 100.00 | | 100.00 | | 100.00 |

For each of the Compositions 1-27, the ingredients are as follows:

the Primary Surfactant 1 is Calsoft LAS99, which is a linear alkyl benzene sulfonic acid available commercially from Pilot Chemical;

the Primary Surfactant 1 Modifier is monoethanolamine (MEA);

the Primary Surfactant 2 is Lutensol A65N, which is a fatty alcohol ethoxylate available commercially from BASF;

the Primary Surfactant 3 is Texapon N70 LS, which is an ether sulfate available commercially from BASF;

the Secondary Surfactant 1 is Dehypon LS 36, which is a fatty alcohol alkoxylate available commercially from BASF;

the Secondary Surfactant 2 Emery 622, which is a coconut oil fatty acid (COFA) available commercially from Emery Oleochemicals;

the Additive 1 is Tinopal CBS-X, which is available commercially from BASF;

the Additive 2 is Savinase 16L, a liquid protease available commercially from Sigma Aldrich;

the Additive 3 is an acrylic:styrene polymer, available commercially from BASF;

the Ionic Liquid is tris(2-hydroxyethyl)methylammonium methylsulfate;

the Additional Solvent 1 (non-aq.) is propylene glycol (PG); and

the Additional Solvent 2 (non-aq.) is glycerine.

Some of the ingredients used to formulate Compositions 1-27, which are listed above, include a solvent such as water. Accordingly, the weight percent of certain components of Compositions 1-27, in relations to the total weight of each composition, are calculated and listed below:

| Formulation | Composition 1 | Composition 2 | Composition 3 |
|---|---|---|---|
| Total Water (Wt. %) | 10.00 | 10.00 | 10.00 |
| Total Solvent (non-aq.) (Wt. %) | 25.16 | 25.16 | 25.16 |
| Total Surfactant (w/MEA) (Wt. %) | 63.76 | 63.76 | 63.76 |
| Water:PG ratio (Wt. %/Wt. %) | 2.00 | 1.85 | 1.70 |
| Formulation | Composition 4 | Composition 5 | Composition 6 |
| Total Water (Wt. %) | 10.00 | 10.00 | 10.00 |
| Total Solvent (non-aq.) (Wt. %) | 25.16 | 25.16 | 25.16 |
| Total Surfactant (w/MEA) (Wt. %) | 63.76 | 63.76 | 63.76 |
| Water:PG ratio (Wt. %/Wt. %) | 2.00 | 1.85 | 1.70 |
| Formulation | Composition 7 | Composition 8 | Composition 9 |
| Total Water (Wt. %) | 15.00 | 15.00 | 15.00 |
| Total Solvent (non-aq.) (Wt. %) | 20.16 | 20.16 | 20.16 |
| Total Surfactant (w/MEA) (Wt. %) | 63.76 | 63.76 | 63.76 |
| Water:PG ratio (Wt. %/Wt. %) | 2.00 | 1.85 | 1.70 |

| Formulation | Composition 10 | Composition 11 | Composition 12 |
|---|---|---|---|
| Total Water (Wt. %) | 15.00 | 15.00 | 15.00 |
| Total Solvent (non-aq.) (Wt. %) | 20.16 | 20.16 | 20.16 |
| Total Surfactant (w/MEA) (Wt. %) | 63.76 | 63.76 | 63.76 |
| Water:PG ratio (Wt. %/Wt. %) | 2.00 | 1.85 | 1.70 |
| Formulation | Composition 13 | Composition 14 | Composition 15 |
| Total Water (Wt. %) | 20.00 | 20.00 | 20.00 |
| Total Solvent (non-aq.) (Wt. %) | 26.27 | 26.27 | 26.27 |
| Total Surfactant (w/MEA) (Wt. %) | 52.76 | 52.76 | 52.76 |
| Water:PG ratio (Wt. %/Wt. %) | 2.75 | 2.25 | 1.75 |
| Formulation | Composition 16 | Composition 17 | Composition 18 |
| Total Water (Wt. %) | 20.00 | 20.00 | 20.00 |
| Total Solvent (non-aq.) (Wt. %) | 26.27 | 26.27 | 26.27 |
| Total Surfactant (w/MEA) (Wt. %) | 52.76 | 52.76 | 52.76 |
| Water:PG ratio (Wt. %/Wt. %) | 5.00 | 10.00 | 20.00 |
| Formulation | Composition 19 | Composition 20 | Composition 21 |
| Total Water (Wt. %) | 25.00 | 25.00 | 25.00 |
| Total Solvent (non-aq.) (Wt. %) | 30.16 | 30.16 | 30.16 |
| Total Surfactant (w/MEA) (Wt. %) | 43.97 | 43.97 | 43.97 |
| Water:PG ratio (Wt. %/Wt. %) | 0.87 | 2.25 | 1.75 |
| Formulation | Composition 22 | Composition 23 | Composition 24 |
| Total Water (Wt. %) | 25.00 | 25.00 | 25.00 |
| Total Solvent (non-aq.) (Wt. %) | 30.16 | 30.16 | 30.16 |
| Total Surfactant (w/MEA) (Wt. %) | 43.97 | 43.97 | 43.97 |
| Water:PG ratio (Wt. %/Wt. %) | 5.00 | 10.00 | 20.00 |
| Formulation | Composition 25 | Composition 26 | Composition 27 |
| Total Water (Wt. %) | 10.00 | 15.00 | 20.00 |
| Total Solvent (non-aq.) (Wt. %) | 24.35 | 19.35 | 14.25 |
| Total Surfactant (w/MEA) (Wt. %) | 63.61 | 63.61 | 63.61 |
| Water:PG ratio (Wt. %/Wt. %) | 0.41 | 0.78 | 1.39 |

The total surfactant represents the sum of the wt. % of each surfactant (e.g. each primary and secondary surfactant) plus the wt. % of surfactant modifier. The water:PG (propylene glycol) ratio represents the ratio of the total wt. % of water to the total wt. % of additional solvent.

Each of Compositions 1-27 is subjected to a variety of stability tests in order to determine the stability of each composition over time, as described in further detail below. Each stability test is conducted according to a common procedure, which includes:
1. adding each composition to a clear, 20 mL vial;
2. visually inspecting each composition to determine an initial state;
3. subjecting each vial, and thus each composition, to the conditions of the particular stability test, as described in further detail below; and
4. visually inspecting each composition to determine a final state.

### Freeze/Thaw Stability:

Each of Compositions 1-27 is subjected to multiple cycles of freezing and thawing in to test the freeze/thaw stability of the compositions. The first cycle of freeze/thaw stability testing is performed as follows:
1. Each composition is visually inspected in order to determine an initial condition.
2. The composition is then stored at −18° C. for 3.5 days, to freeze the composition.
3. Once frozen, each composition is then stored at 23° C. for 3.5 days, to thaw the composition.
4. Once thawed, the composition is then visually inspected to determine whether a phase-separation has occurred (recorded as a “fail”), or not (recorded as a “pass”). Visual determination of a change in the refractive index of a composition, without a visual determination of bulk phase-separation, is recorded as a “pass” for that composition.

Steps 2-4 above are then repeated for each subsequent cycle of freeze/thaw stability testing, with each composition being subjected to a total of 3 cycles (i.e., each of steps 2-4 above are conducted, sequentially, two times after the conclusion of the first cycle) of freeze/thaw stability testing. The determination made upon visual inspection (step 4) of a composition after the third cycle (e.g. “pass” or “fail”) is recorded as the result of the freeze/thaw stability test for that composition. The result of the freeze/thaw stability testing for each of compositions 1-27 are listed and described below.

### Low-Temperature Stability:

Each of Compositions 1-27 is subjected to multiple weeks of low-temperature storage to test the low-temperature stability of the compositions. The first week of the low-temperature stability testing is performed as follows:
1. Each composition is visually inspected in order to determine an initial condition.
2. Each composition is then stored at 4° C. for 1 week.
3. After the 1 week, each composition is then stored at room-temperature (21-23° C.) until the composition is equilibrated to room-temperature.
4. After being equilibrated to room-temperature, each composition is then visually inspected to determine whether a phase-separation has occurred (recorded as a “fail”), or not (recorded as a “pass”). Visual determination of a change in the refractive index of a composition, without a visual determination of bulk phase-separation, is recorded as a “pass” for that composition.

Steps 2-4 above are repeated for each subsequent week of low-temperature stability testing, with each composition being subjected to up to 12 weeks (i.e., each of steps 2-4 above are conducted, sequentially, up to 11 times after the conclusion of the first week) of low-temperature stability testing. The determination made upon visual inspection (step 4) of a composition during the final week (e.g. “pass” or “fail”) is recorded as the result of the low-temperature stability test for that composition. The result of the low-temperature stability testing for each of compositions 1-27 are listed and described below.

### Room-Temperature Stability:

Each of Compositions 1-27 is subjected to multiple weeks of room-temperature storage to test the room-temperature stability of the compositions. The first week of the room-temperature stability testing is performed as follows:
1. Each composition is visually inspected in order to determine an initial condition.
2. Each composition is then stored at room-temperature (21-23° C.) for 1 week.
3. After the 1 week, each composition is then visually inspected to determine whether a phase-separation has occurred (recorded as a “fail”), or not (recorded as a “pass”). Visual determination of a change in the refractive index of a composition, without a visual determination of bulk phase-separation, is recorded as a “pass” for that composition.

Steps 2 and 3 above are repeated for each subsequent week of room-temperature stability testing, with each composition being subjected to up to 12 weeks (i.e., each of steps 2 and above are conducted, sequentially, up to 11 times after the conclusion of the first week) of room-temperature stability testing. The determination made upon visual inspection (step 3) of a composition during the final week (e.g. “pass” or “fail”) is recorded as the result of the room-temperature stability test for that composition. The result of the room-temperature stability testing for each of compositions 1-27 are listed and described below.

### High-Temperature Stability:

Each of Compositions 1-27 is subjected to multiple weeks of high-temperature storage to test the high-temperature stability of the compositions. The first week of the high-temperature stability testing is performed as follows:
1. Each composition is visually inspected in order to determine an initial condition.
2. Each composition is then stored at 50° C. for 1 week.
3. After the 1 week, each composition is then stored at room-temperature (21-23° C.) until the composition is equilibrated to room-temperature.
4. After being equilibrated to room-temperature, each composition is then visually inspected to determine whether a phase-separation has occurred (recorded as a “fail”), or not (recorded as a “pass”). Visual determination of a change in the refractive index of a composition, without a visual determination of bulk phase-separation, is recorded as a “pass” for that composition.

Steps 2-4 above are repeated for each subsequent week of high-temperature stability testing, with each composition being subjected to up to 12 weeks (i.e., each of steps 2-4 above are conducted, sequentially, up to 11 times after the conclusion of the first week) of high-temperature stability testing. The determination made upon visual inspection (step 4) of a composition during the final week (e.g. “pass” or “fail”) is recorded as the result of the high-temperature stability test for that composition. The result of the high-temperature stability testing for each of compositions 1-27 are listed and described below.

### Freeze/Thaw Stability:

Results of Freeze/Thaw Stability Testing

| Composition | Initial Condition | Final Result |
|---|---|---|
| Composition 1 | Clear | Pass |
| Composition 2 | Clear | Pass |
| Composition 3 | Clear | Pass |
| Composition 4 | Clear | Pass |
| Composition 5 | Clear | Pass |
| Composition 6 | Clear | Pass |
| Composition 7 | Clear | Pass |
| Composition 8 | Clear | Pass |
| Composition 9 | Clear | Pass |
| Composition 10 | Clear | Fail |
| Composition 11 | Clear | Pass |
| Composition 12 | Clear | Pass |
| Composition 13 | Clear | Pass |
| Composition 14 | Clear | Pass |
| Composition 15 | Clear | Pass |
| Composition 16 | Clear | Pass |
| Composition 17 | Not Homogeneous | Fail |
| Composition 18 | Not Homogeneous | Fail |
| Composition 19 | Clear | Pass |
| Composition 20 | Clear | Pass |
| Composition 21 | Clear | Pass |
| Composition 22 | Clear | Pass |
| Composition 23 | Clear | Pass |
| Composition 24 | Clear | Pass |
| Composition 25 | Clear | Pass |
| Composition 26 | Clear | Pass |
| Composition 27 | Clear | Pass |

As demonstrated by the results shown above, the exemplary compositions 1-27 have excellent freeze/thaw stability.

### Low-Temperature Stability:

Results of Low-Temperature Stability Testing

| Composition | Initial Condition | Weeks In Storage | Final Result |
|---|---|---|---|
| Composition 1 | Clear | 5 | Pass |
| Composition 2 | Clear | 5 | Pass |
| Composition 3 | Clear | 5 | Pass |
| Composition 4 | Clear | 5 | Pass |
| Composition 5 | Clear | 5 | Pass |
| Composition 6 | Clear | 5 | Pass |
| Composition 7 | Clear | 5 | Pass |
| Composition 8 | Clear | 5 | Pass |
| Composition 9 | Clear | 5 | Pass |
| Composition 10 | Clear | 5 | Pass |
| Composition 11 | Clear | 5 | Pass |
| Composition 12 | Clear | 5 | Pass |
| Composition 13 | Clear | 5 | Pass |
| Composition 14 | Clear | 5 | Pass |
| Composition 15 | Clear | 5 | Pass |
| Composition 16 | Clear | 1 | Fail |
| Composition 17 | Not homogenous | 1 | Fail |
| Composition 18 | Not homogenous | 1 | Fail |
| Composition 19 | Clear | 5 | Pass |
| Composition 20 | Clear | 5 | Pass |
| Composition 21 | Clear | 5 | Pass |
| Composition 22 | Clear | 3 | Pass |
| Composition 23 | Clear | 3 | Pass |
| Composition 24 | Clear | 3 | Pass |
| Composition 25 | Clear | 9 | Pass |
| Composition 26 | Clear | 9 | Pass |
| Composition 27 | Clear | 9 | Pass |

As demonstrated by the results shown above, the exemplary compositions 1-27 have excellent low-temperature storage stability.

### Room-Temperature Stability:

Results of Room-Temperature Stability Testing

| Composition | Initial Condition | Weeks In Storage | Final Result |
|---|---|---|---|
| Composition 1 | Clear | 5 | Pass |
| Composition 2 | Clear | 5 | Pass |
| Composition 3 | Clear | 5 | Pass |
| Composition 4 | Clear | 5 | Pass |
| Composition 5 | Clear | 5 | Pass |
| Composition 6 | Clear | 5 | Pass |
| Composition 7 | Clear | 5 | Pass |
| Composition 8 | Clear | 5 | Pass |
| Composition 9 | Clear | 5 | Pass |
| Composition 10 | Clear | 5 | Pass |
| Composition 11 | Clear | 5 | Pass |
| Composition 12 | Clear | 5 | Pass |
| Composition 13 | Clear | 5 | Pass |
| Composition 14 | Clear | 5 | Pass |
| Composition 15 | Clear | 5 | Pass |
| Composition 16 | Clear | 3 | Pass |
| Composition 17 | Not homogenous | 1 | Fail |
| Composition 18 | Not homogenous | 1 | Fail |
| Composition 19 | Clear | 5 | Pass |
| Composition 20 | Clear | 5 | Pass |
| Composition 21 | Clear | 5 | Pass |
| Composition 22 | Clear | 3 | Pass |
| Composition 23 | Clear | 3 | Pass |
| Composition 24 | Clear | 3 | Pass |
| Composition 25 | Clear | 9 | Pass |
| Composition 26 | Clear | 9 | Pass |
| Composition 27 | Clear | 9 | Pass |

As demonstrated by the results shown above, the exemplary compositions 1-27 have excellent room-temperature storage stability.

### High-Temperature Stability:

Results of High-Temperature Stability Testing

| Composition | Initial Condition | Weeks In Storage | Final Result |
|---|---|---|---|
| Composition 1 | Clear | 5 | Pass |
| Composition 2 | Clear | 5 | Pass |
| Composition 3 | Clear | 5 | Pass |
| Composition 4 | Clear | 5 | Pass |
| Composition 5 | Clear | 5 | Pass |
| Composition 6 | Clear | 5 | Pass |
| Composition 7 | Clear | 5 | Pass |
| Composition 8 | Clear | 5 | Pass |
| Composition 9 | Clear | 5 | Pass |
| Composition 10 | Clear | 5 | Pass |
| Composition 11 | Clear | 5 | Pass |
| Composition 12 | Clear | 5 | Pass |
| Composition 13 | Clear | 5 | Pass |
| Composition 14 | Clear | 5 | Pass |
| Composition 15 | Clear | 5 | Pass |
| Composition 16 | Clear | 2 | Fail |
| Composition 17 | Not homogenous | 1 | Fail |
| Composition 18 | Not homogenous | 1 | Fail |
| Composition 19 | Clear | 5 | Pass |
| Composition 20 | Clear | 5 | Pass |
| Composition 21 | Clear | 5 | Pass |
| Composition 22 | Clear | 3 | Pass |
| Composition 23 | Clear | 2 | Fail |
| Composition 24 | Clear | 1 | Fail |
| Composition 25 | Clear | 9 | Pass |
| Composition 26 | Clear | 9 | Pass |
| Composition 27 | Clear | 9 | Pass |

As demonstrated by the results shown above, the exemplary compositions 1-27 have excellent high-temperature storage stability.

The above results demonstrate that the exemplary compositions are stable with respect to conditions of high, room, and low-temperature storage, freeze/thaw conditions, and are thus suitable for encapsulation in a water-soluble film pouch.

All combinations of the aforementioned embodiments throughout the entire disclosure are hereby expressly contemplated in one or more non-limiting embodiments even if such a disclosure is not described verbatim in a single paragraph or section above. In other words, an expressly contemplated embodiment may include any one or more elements described above selected and combined from any portion of the disclosure.

One or more of the values described above may vary by ±5%, ±10%, ±15%, ±20%, ±25%, etc. so long as the variance remains within the scope of the disclosure. All values and ranges of values therebetween are also expressly contemplated herein in various non-limiting embodiments. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e. from 0.1 to 0.3, a middle third, i.e. from 0.4 to 0.6, and an upper third, i.e. from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

What is claimed is:

1. An encapsulated laundry cleaning composition comprising:
A. a core cleaning composition comprising;
a detergent, and
a solvent system comprising an ionic liquid and water; and
B. a water-soluble film disposed about said core cleaning composition;
wherein said water-soluble film has a disintegration time of less than 90 seconds as determined at 40° C. using distilled water according to MSTM 205 when disposed about said core cleaning composition.

2. The encapsulated laundry cleaning composition of claim 1, wherein said solvent system further comprises an additional solvent present in an amount of from 10 to 35 parts by weight per 100 parts by weight of said core cleaning composition.

3. The encapsulated laundry cleaning composition of claim 2, wherein said additional solvent comprises: propylene glycol, ethylene glycol, butylene glycol, or mono or di ethers thereof glyme; diglyme; triglyme; polyethylene glycol having a weight average molecular weight of from 106 to 600 g/mol; 1,3-propanediol; 1,4-butanediol; glycerine; or combinations thereof.

4. The encapsulated laundry cleaning composition of any one of claims 1-3, wherein said water-soluble film comprises: polyvinyl alcohol; polyvinyl acetate; polyvinyl acetate having 88-98% of the total number of acetate groups hydrolyzed; gelatin; or combinations thereof.

5. The encapsulated laundry cleaning composition of any one of claims 1-4, wherein said water is present in an amount of from 1 to 35 parts by weight per 100 parts by weight of said core cleaning composition.

6. The encapsulated laundry cleaning composition of any one of claims 1-5, wherein said detergent is present in an amount from 30 to 90 parts by weight per 100 parts by weight of said core cleaning composition.

7. The encapsulated laundry cleaning composition of any one of claims 1-6, wherein said detergent comprises a surfactant present in an amount of from 30 to 70 parts by weight per 100 parts by weight of said core cleaning composition.

8. The encapsulated laundry cleaning composition of claim 7, wherein said surfactant comprises: an alcohol alkoxylate; an alkyl/aryl ether sulfate; an alkyl/aryl sulfonate; an alkyl/aryl sulfate; an alkyl betaine; a C₁₂-C₁₈ dialkyl quaternary ammonium salt; an ethyleneoxide/propylene oxide block copolymer; or combinations thereof.

9. The encapsulated laundry cleaning composition of any one of claims 1-8, wherein said ionic liquid comprises:
A. a cation having a structure according to the formula 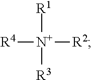
and
B. an anion having a structure according to the formula 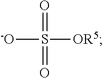
wherein each of R¹-R⁵ is independently a linear or branched C₁-C₁₀ alkyl, aryl, or alkylaryl group; and
wherein each of R¹-R⁵ is optionally substituted with N, P, S, and O.

10. The encapsulated laundry cleaning composition of any one of claims 1-9, wherein said ionic liquid is tris(2-hydroxyethyl)methylammonium methylsulfate.

11. The encapsulated laundry cleaning composition of any one of claims 1-9, wherein said ionic liquid is present in an amount of from 10 to 35 parts by weight per 100 parts by weight of said core cleaning composition.

12. The encapsulated laundry cleaning composition of any one of claims 1-11, wherein said core cleaning composition further comprises an additive that is a foam regulator, an anti-redeposition agent, an enzyme, a buffer, a builder, an alkali, an active oxygen bleach, an antimicrobial agent, an optical brightener, a rheology modifier, a thickener, a fabric softener, a fragrance, a preservative, a corrosion inhibitor, a dye fixative, a shading dye, a dye transfer inhibitor, a hydrotrope, or combinations thereof.

13. The encapsulated laundry cleaning composition of claim 12, wherein said additive is a polymeric reaction product of: acrylic acid or derivatives thereof acrylate or derivatives thereof maleic anhydride or derivatives thereof polyethyleneimine; or combinations thereof.

14. The encapsulated laundry cleaning composition of claim 12, wherein said additive is an enzyme that is an amylase, a protease, a mannanase, a cellulase, or combinations thereof.

15. The encapsulated laundry cleaning composition of any one of claims 1-14, wherein the stability of the water-soluble film is such that no amount of core cleaning composition leaks through the water-soluble film when the encapsulated laundry cleaning composition is stored at 25° C. for a period of 6 months.

16. The encapsulated laundry cleaning composition of any one of claims 1-15, wherein the stability of the water-soluble film is such that no phase-separation of the core cleaning composition is visually detected after the encapsulated laundry cleaning composition is frozen and thawed three times.

17. The encapsulated laundry cleaning composition of any one of claims 1-16, wherein the stability of the core cleaning composition is such that no phase-separation of the core cleaning composition is visually detected after the encapsulated laundry cleaning composition is stored at 4° C. for a period of 12 weeks.

18. The encapsulated laundry cleaning composition of any one of claims 1-17, wherein the stability of the core cleaning composition is such that no phase-separation of the core cleaning composition is visually detected after the encapsulated laundry cleaning composition is stored at 25° C. for a period of 12 weeks.

19. The encapsulated laundry cleaning composition of any one of claims 1-18, wherein the stability of the core cleaning composition is such that no phase-separation of the core cleaning composition is visually detected after the encapsulated laundry cleaning composition is stored at 50° C. for a period of 12 weeks.

20. The encapsulated laundry cleaning composition of any one of claims 1-19, wherein said water-soluble film remains stable for 6 months at 25° C. when disposed about said core cleaning composition.

21. An encapsulated laundry cleaning composition comprising:
A. a core cleaning composition comprising;
a detergent present in an amount of from 30 to 89 parts by weight per 100 parts by weight of said core cleaning composition, said detergent comprising a surfactant, an additive, or combinations thereof,
tris(2-hydroxyethyl)methylammonium methylsulfate present in an amount of from 1 to 25 parts by weight per 100 parts by weight of said core cleaning composition,
water present in an amount of from 10 to 30 parts by weight per 100 parts by weight of said core cleaning composition, and
propylene glycol present in an amount of from 0 to 35 parts by weight per 100 parts by weight of said core cleaning composition,
wherein said water and said propylene glycol are present in a weight ratio of said water to said propylene glycol of from 0 to 5; and
B. a polyvinyl alcohol film disposed about said core cleaning composition;
wherein said polyvinyl alcohol film has a disintegration time of less than 90 seconds as determined at 40° C. using distilled water according to MSTM 205 when disposed about said core cleaning composition, and
wherein said polyvinyl alcohol film remains stable for 6 months at 25° C. when disposed about said core cleaning composition; and
wherein said core cleaning composition remains stable at 4° C. for a period of 12 weeks when encapsulated with said polyvinyl alcohol said core cleaning composition.
